(19) United States
(12) Patent Application Publication
(10) Pub. No.: US 2018/0121912 A1
(43) Pub. Date: May 3, 2018

(54) S&M to locate vending machines, select on-screen, and click to buy

(71) Applicant: Fernando Morales, Rancho Viejo, TX (US)

(72) Inventor: Fernando Morales, Rancho Viejo, TX (US)

(21) Appl. No.: 15/330,755

(22) Filed: Nov. 2, 2016

(51) Int. Cl. G06Q 20/38; G06Q 20/10; G06Q 20/32

(52) U.S. Cl. CPC G06Q 20/3829; H04L 67/42; G06Q 20/3223; G06Q 20/10

(57) ABSTRACT

The present invention teaches a cashless way to purchase products or services from offline Vending Machines VM in which the seller receives an electronic transfer of funds before the machine dispenses the purchased products. Using one copy of the WordPress software for each offline VM the sellers can receive payments directly into their PayPal accounts.

Buyers can pay using their credit cards or PayPal account. Buyers using Google Maps can locate the nearby machines and the web site associated to them, so that they can purchase products walking to the desired machine. When buyers get close to the VM a special message created and sent by its Smart Cellular Phone SCP commands the VM to dispense the purchased product. The special message contains synchronized time information to protect against message cloning to obtain products without paying.

REFERENCES CITED

| | | |
|---|---|---|
| 9,111,405 | Aug. 18, 2015 | Barragan et al. |
| 8,564,405 | Oct. 22, 2013 | Barragan Trevino et al. |
| 8,487,744 | Jul. 16, 2013 | Barragan Trevino et al. |
| 8,269,604 | Sep. 18, 2012 | Barragan Trevino et al. |
| 8,820,575 | Sep. 2, 2014 | Nicholson |
| 8,693,984 | Apr. 8, 2014 | Webb |
| 8,424,759 | Apr. 23, 2013 | Degironemo |
| 8,238,901 | Aug. 7, 2012 | Pudney, et al. |
| 7,861,927 | Jan. 4, 2011 | DeGironemo |
| 7,110,954 | Sep. 19, 2006 | Yung, et al. |
| 6,844,813 | Jan. 18, 2005 | Hardman |
| 6,807,532 | Oct. 19, 2004 | Kolls |
| 6,658,248 | Dec. 2, 2003 | Lee |
| 6,615,183 | Sep. 2, 2003 | Kolls |
| 6,609,103 | Aug. 19, 2003 | Kolls |
| 6,606,602 | Aug. 12, 2003 | Kolls |
| 6,604,087 | Aug. 5, 2003 | Kolls |
| 6,604,086 | Aug. 5, 2003 | Kolls |
| 6,601,040 | Jul. 29, 2003 | Kolls |
| 6,601,039 | Jul. 29, 2003 | Kolls |
| 6,601,038 | Jul. 29, 2003 | Kolls |
| 6,601,037 | Jul. 29, 2003 | Kolls |
| 6,584,309 | Jun. 24, 2003 | Whigham |
| 6,581,825 | Jun. 24, 2003 | Rickerson, Jr. |
| 6,450,407 | Sep. 17, 2002 | Freeman, et al. |
| 6,038,491 | Mar. 14, 2000 | McGarry, et al. |
| 5,930,771 | Jul. 27, 1999 | Stapp |
| 4,951,308 | Aug. 21, 1990 | Bishop et al. |
| 20140313882 | Oct. 23, 2014 | Rucker; Jeff; et al. |
| 20140179231 | Jun. 26, 2014 | Charania; Rahim; et al. |
| 20120316672 | Dec. 13, 2012 | Nicholson; Robert |
| 20110258023 | Oct. 20, 2011 | DeGironemo; William A. |
| 20090156201 | Jun. 18, 2009 | Pudney; Christopher David; et al. |
| 20090057394 | Mar. 5, 2009 | DeGironemo; William A. |
| 20050108158 | May 19, 2005 | Prisant, Simon |
| 20050059339 | Mar. 17, 2005 | Honda, Toshinobu; et al. |
| 20030169180 | Sep. 11, 2003 | Hardman, Simon F. |
| 20030078895 | Apr. 24, 2003 | MacKay, George |
| 20030074106 | Apr. 17, 2003 | Butler, Glenn D. |
| 20020128932 | Sep. 12, 2002 | Yung, Hon Ching; et al. |
| 20010035425 | Nov. 1, 2001 | Rocco, Mark; et al. |
| 20010016819 | Aug. 23, 2001 | Kolls, H. Brock |

None of these patents describes or claims anything similar or even close to what I'm describing herein.

The following two patents describe and claim something similar or close to what I'm describing herein.

The U.S. Pat. No. 8,856,045 granted on Oct. 7, 2014 to Patel, et al. claims priority on a Provisional application for patent filed Dec. 18, 2013.

The U.S. Pat. No. 9,240,007 granted on Jan. 19, 2016 Barragan Trevino, et al. claims priority on a Provisional application for patent filed Oct. 3, 2013.

The two Provisional applications for patent describe an identical method of payment. The following is a portion of the one filed on Oct. 3, 2013:

There is however, one single electronic interface that is present in each VM of this new type: a Bluetooth Low Energy (BLE) transceiver which has the ability to issue command and control actions to the VM. In specific terms, the VM could be a standard machine+MDB-based controller card (MDB: Multi-Drop Bus) without any coin and/or bill acceptors, without any cashless sales devices, and without any telemetry devices. Instead, there will be a single BLE transceiver device that is attached to the MDB.

In a different embodiment, the BLE device may be a very small, battery powered device that has reduced control functionality but still serves as an application endpoint (as described later.)

The BLE device transmits a proximity “beacon” signal that is detectable by compatible smartphone devices. A system such as this was recently introduced by Apple Computer called iBeacon and is described here. The BLE device continuously transmits this beacon and is therefore always ready for a transaction.

The transmitted beacon signal is used to “awaken” the corresponding application on a consumer's smartphone device who is in nearby proximity to the BLE enabled VM. In other words, once a consumer is in close enough proximity to a BLE enabled VM, the application will activate and connect to the VM over the BLE wireless protocol. Once this data connection is established, the smartphone application serves as a client endpoint for the sales transaction.

The application sends requests to the centralized server (via 3G/Wi-Fi) to identify the buyer, authorize the sale, collect the funds, display marketing or other promotional/loyalty information. Once authorized, the smartphone app instructs the BLE device in the VM to vend the product.

The invention described in my Provisional Application Patent 62/285,626 filed on Nov. 4, 2015 uses the same Bluetooth Low Energy (BLE) circuit for the communication between the vending machine and the SCP as mentioned by Patel and Barragan patents, they are using the BLE circuit inside the vending machines, to generate a beacon to wake up the buyer's SCP and to create a payment request when the buyer's SCP wakes up and to send said payment request to the buyer's SCP to re-send said payment request to the centralized server to identify the buyer, authorize the sale, collect the funds, create a matching payment response, send the said matching payment response to the buyer's SCP, and from the buyer's SCP send the said matching payment response to the BLE circuit to command it to dispense a product. This invention uses the BLE circuit without the beacon signal and without the payment request, it is always attentive to receive a very special message that is synchronized with an internal BLE circuit's clock, the said message is different each time so that it can be retransmitted many times to the BLE circuit, and only dispense the products purchased once.

Let me explain the difference; to begin, the buyer locates a vending machine using a SCP and its location, to retrieve and click to buy the desired product offered by that particular vendor. Then, the SCP gathers the data needed to prepare the encrypted message acceptable by that particular vending machine to deliver the purchased product or service, and transmits that message when the SCP is nearby the machine. Then, the buyer SCP waits until the vending machine acknowledges the message and replies with the temperature of the product to be delivered. Then, if the consumer SCP accepts that temperature the vending machine delivers the product. In the event that the machine requires the buyer's input, the buyer follows the instructions to obtain the product or service desired.

From the consumer's point of view, my invention describes a totally different buying experience, one that overcomes the limitations of the mentioned two patents in which consumers need to know the following information about each VM location: consumer's SCP connectivity, products offered, average temperature of the products delivered, and the probability that the desired product will be available.

From the VM owner's point of view my invention describes a totally different business alternative, one that provides a universal consumer interface, without the middle man in each transaction, because the proceeds of any sale could go directly from the consumer's credit card or PayPal account to the VM owner's PayPal account at the time of each transaction.

### Definitions

Adapter Module=App running in a SCP=Electronic circuit that may be inserted in-line within a multi-drop bus (MDB) or using the EVA-DTS or Executive Standard Protocols of a machine depicted in FIGS. 6, 7, and 8.
ANSWER=Is the VM response to an ORDER, see FIGS. 14 and 15 for more details.
API=An Application Programming Interface (API) is a set of functions, procedures, methods, or classes used by computer programs to request services.
App=Software Application designed to run on an SCP. When the SCP performs a task, the task was really performed by the App using the hardware of the SCP.
BB(Y)=Buyer's Balance (Y) Folder that contains, as access key Y, the buyer's email address, buyer's SCP IMEI number, buyer's PIN, and Password, and as data:
   Buyer's EID (Encrypted Buyer's information).
   Buyer's Information File:
      Buyer's name, buyer's age, buyer's driver license photo, buyer's cellular number, and the buyer's SCP Serial Number.
   List of Cash Sources File:
      List of available balances from purchases for each of the following service providers: Google Wallet, Android Pay, Apple Pay, PayPal, Samsung Pay, Square Cash, Bitcoin, etc., and with a new service created by TWE (The Whole Ecosystem) that could be called Mwallet.
   Past Buying Transactions File:
      List of previous transactions, each one including: date/time of the purchase, the source of funding, product number, amount, precise GPS location of the VM, Number of the VM in that location, the email associated to the vending machine, and the facial picture of who entered the PIN to instruct the VM to dispense the law-restricted product.
   Video File for Proving Age:
      The video file showing the buyer's first interview showing the driver license in hand.
   List of Pictures File:
      Used for the ID check. It is the list of facial pictures, acquired at the time someone clicked to instruct the VM to deliver the law-restricted product, time of the event, and the approval status of each picture.
Bitcoin=bitcoin=Is a payment system invented by Satoshi Nakamoto, who published the invention in 2008 and released it as an open-source software in 2009. The system is peer-to-peer; users can transact directly without needing an intermediary. Transactions are verified by network nodes and recorded in a public distributed ledger called the block chain. The ledger uses its own unit of account, also called bitcoin. The system works without a central repository or single administrator, which has led the U.S. Treasury to categorize it as a decentralized virtual currency. Bitcoin is often called the first cryptocurrency, although prior systems existed. Bitcoin is more correctly described as the first decentralized digital currency. It is the largest of its kind in terms of total market value.
Buyer=buyer=a SCP user that downloads the buyer's App and opens a buyer's account in TWE, enters all data required, and deposits money from at least one of his/her PSP (Pay Service Provider) into one of the BB(Y) folder balances to be ready to purchase VM products or services.
BLE=Bluetooth Low Energy.
Chef=is a person who is a highly trained, skilled, professional cook who is proficient in all aspects of food preparation of a particular cuisine.
Cloud stored data=CS=URL=Web page
CS=Cloud Storage=Cloud=Cloud data=intelligent or not, it is a world wide data storage distributed all over the planet that could contain one or two types of folders: folders for buyers and for VM. It could be just data storage with restriction to who could write on it.
   Folders for VM or VC are called VM(X):
      Folders VM(X) are accessible by X and could be read-only data for buyers. X could contain: Earth's latitude and longitude, Number, seller's PIN, and a Password. The Number is equal from 1 to the number of VMs at that location. The seller's PIN is generated by the seller at the time of initialization of the VM(X). The Password controls the App's access privileges see Password definition for more details.
   Folders for Buyers are Called BB(Y):
      Folders BB(Y) are accessible by Y, Y containing the buyer's email address, buyer's SCP International Mobile Station Equipment Identity (IMEI), buyer's PIN, and a Password. The buyer's PIN is generated by the buyer at the time of initialization of the BB(Y). The Password controls the App's access privileges including: the PIN requirements (one Password will allow the App to handle each piece of information in the folder as not visible, read-only, written-once after it adds or subtracts an amount to a variable each time that a transaction record that includes that amount is written-once, and visible only after a valid EID, number generated by the CS, is written-once in the transaction record), and other Passwords should allow to read or write over any piece of information.
Communicate=the action of sending data, the action of receiving data, the action of sending or receiving an email, the action of modifying a bit of data and/or a record of data, using wire as a medium of communication, using wireless as a medium of communication, Internet, cellular infrastructure, Wi-Fi, Bluetooth, low power Bluetooth, NFC, communication using: audio (using the SCP speaker), light (using the SCP screen), image (using an image displayed in the SCP screen), infrared (using the SCP infrared emitter), and/or any combination of mediums, etc.
EID=is a number generated by the CS at the time that the creation of the BB(Y) folder occurred. It is an encrypted representation of the buyer's information. This number is read-only for buyers and sellers.
Electronic Wallet Service Provider=Google Wallet, Apple Pay, Android Pay, PayPal, Square Cash, or Samsung Pay, etc.
Email=email, SMS text, cloud posted message associated to a mobile device or email address.
ENP=Encrypted Number Purchased is a number that represents an amount of money paid to the seller for that unique SCP and that can be used only once. It contains the SCP's phone number, IMEI number, deposit date, past deposit date, and the amount. The App code contains the decryption key and can verify the phone's number, IMEI, Sequential number, and date, to prevent double deposits.
Food Service Provider=FSP=VM=Fast Food restaurant, Food Court Vendor, Food Truck, Stadium vendor, coffee vendor, etc.
GPS=Global Positioning System. It is a space-based navigation system that using four or more GPS satellites provides location and time information.
Google Wallet=PSP=Payment Service Provider
IMEI=International Mobile Station Equipment Identity. It is a 15-digit or 17-digit code that uniquely identifies mobile phone sets.
Long-range communication technology=the subset of Communicate (wireless as a medium of communication, Internet, cellular infrastructure, Wi-Fi, and other similar mediums).
Multi-Drop Bus=MDB and/or other protocols.
MDB=Multi-Drop Bus Protocol used by some VM to connect multiple payment devices.
Message=the message described in FIG. 14, or any other message that accomplishes the tasks described in this invention.
Mobile device=SCP
Mwallet=Machine Wallet could be a new service created by the owners of this patent, and could be a service similar to Google Wallet, Apple Pay, Android Pay, PayPal, Square Cash, or Samsung Pay.
ORDER=Is a number created by the person that writes the App code to communicate to the VM a command or to ask a question. See FIGS. 14 and 15 for more details.
Payment accepting unit=VM=VC
Payment service providers=PSP=Google Wallet, Android Pay, Apple Pay, PayPal, Samsung Pay, Square Cash, Bitcoin, etc.
Password=The Password controls the App's access privileges, including the PIN needs. For example, the buyer's App Password will allow the App to handle each piece of information in the folder as (not visible, read-only, written-once, add or subtract one to a variable each time that written-once a transaction record that includes that +/−, and visible-only-after written-once in transaction record a valid EID), other Passwords should allow to (Read/Write) over any piece of information.
PIN=Personal Identification Number created by the App User at the time of registration.
Private Key=part of the VM(X) definition; an encryption Key (created by the owner of the VM to protect the communication with the VM).
PRODUCT=is anything that can be offered to a market that might satisfy a want or need.
PRODUCT #=Is a number that allows the VM to dispense that PRODUCT, the first 4 bits of that number defines the VM hardware protocol to dispense the desired PRODUCT in that particular VM. The rest is the data required for that particular VM to dispense the PRODUCT.
PSP=Pay Service Provider=Google Wallet, Apple Pay, Android Pay, PayPal, Square Cash, Samsung Pay, Bitcoin, Mwallet, etc.
SCP=Smart Cellular Phone, Tablet, or any electronic device that is able to decode GPS signals and Communicate to the Cloud.
Security technology=as a general accepted term at the time of this invention and/or describe in this document.
Seller=seller=the person that owns one or more VMs and/or the operator of a fast food restaurant, food truck operator; there are thousands of them in the U.S.
Short-range communication technology=the subset of Communicate (Wi-Fi, Bluetooth, low power Bluetooth, NFC, communication using: audio (using the SCP speaker), light (using the SCP screen), image (using an image displayed in the SCP screen), infrared (using the SCP infrared emitter), and/or any combination of mediums, etc.)
SIV=Seller ID Verification is performed by a person assigned by the VM owner to receive an email from a buyer asking to compare the picture of the person requesting the VM to deliver the law-restricted product with the picture of the buyer's driver license previously stored in the BB(Y) folder.
SPA=System Payments Administrator is a person that receives email from the seller, instructing to transfer all proceeds collected using a particular PSP to his/her account with that particular PSP. There could be one designated for the whole system or one designated as per country, state, county, municipality, city, area code, zip code, etc.
STA=System Transfer Administrator is a person that receives email from a buyer's PSP account informing that an amount was sent to his/her account with the same or different PSP company. There could be one designated for the whole system or one designated as per country, state, county, municipality, city, area code, zip code, etc.
TIME=Could be the date and time of the last restocking, or any other reference associated to the VM, that can be running or calculated by the VM and/or VC App.
TIMER=To the number of seconds passed from the date and time of the last restocking or other event, and could be used to protect the cloning of the communication with the VM.
TWE=The Whole Ecosystem, is the CS, and all the Apps that communicate with the CS. The owner of the TWE should have a registered account with each of the PSPs in order to receive and transfer funds to sellers.
USB=Is a Universal Serial Bus interface; it is also a digital storage with a USB interface. When a USB drive is connected to the BLE112, it contains an Encryption Key, a VM-ID, and data to instruct the BLE112 how to interface with the VM hardware, and also contains the VM inventory.
URL=URI=Web page=an https:blablabla=VMxyz.abcd.com
VC=Vending chef is a chef using the Chef's App as tool; in the street, food court, food truck, stadium, coffee shops, ice cream shops, bars, beach rentals, and services etc.
VC-ID=VC RANDOM #, Is a random number created by the owner to identify that particular Chef's App and to further protect the communication between the Chef's App and the Buyer's App.
VM-ID=VM RANDOM #, Is a random number created by the owner of the VM to identify that particular VM and to further protect the communication between the VM and the Buyer's App.
VM=Vending Machine or SCP, and/or an unusual hardware device.
VM(X)=Vending Machine Folder could contain, as access key X, the: GPS precise location of the VM, VM Number of VM in that location, seller's PIN, and a Password.
   VMs' Encryption and ID could contain: An encryption Key (created by the owner of the VM to protect the communication with the VM), VMID, and a TIME.
   VMs' Information File could contain:
      Physical address of that VM, location inside the building of that VM, seller's ID Verification email, email addresses of the persons responsible for that VM (Restocking, Cooling, Liking, etc.), number of temperatures taken, average temperature, last temperature reported, date of the last temperature reported, payments accepted (Google Wallet, Apple Pay, Android Pay, PayPal, Square Cash, Samsung Pay, Bitcoin, Mwallet, etc.), revenues balances (Google Wallet, Apple Pay, Android Pay, PayPal, Square Cash, Samsung Pay, Bitcoin, Mwallet, etc.), and type of VM' hardware to dispense products: for example one type for sequential (1 to 64, another for a matrix (16×16) of products, or binary (4×4) output interface, etc.), is: (Real Product, Parking space, etc.), number of products on the VM, use USB drive to initialize, type of interface with the VM: (Serial, Parallel, sequential, Multi Drop Bus (MDB) Protocol, USB, etc.)
   VMs' products File could contain:
      The list of products, each one with the following information: product number, product name, product description, Number type, product type (product/service/cash), product picture, product video, quantity available, maximum quantity that can be stored, expiration date, Price, adjustment type (dynamic up/down price adjustment according to: expiration date, calendar, and/or availability and expected demand), restrictions (sales restrictions by age, and/or agenda), verification procedures (PIN, signature, and/or age), verification type (showing driver license and face picture of the buyer, Passport, SSN, etc.), etc.
   VMs' Past Sales Transactions File could contain:
      Timestamp; Type; product number; product name; product description; price obtained; and the buyer's phone number, email address, and if required pictures of the driver license, faces, and signature.
   VMs' Cash Withdrawal Transactions File could contain:
      Timestamp, amount withdrawn, and total amount transferred to that PSP account owned by the owner of the VM on that date.
   VMs' Restocking Events File could contain:
      Timestamp; pictures of the VM back door loaded with products; all the information about the products loaded in that restocking event or about issues related to the maintenance of that VM; and a copy of the email of the restocking person and a copy of the email of the person informed of the maintenance issue, if any.
Web page=WVM(X)=URL
WVM(X)=Www.VM(X)=URLVM(X)=URL=Internet page that contains: the list of items offered by the sellers, sellers' email(s), SCP number, and all the information required by the Payment Service Provider to complete the sale.
X=Folder access key could contain: the Earth's latitude and longitude, number, seller's PIN, and a Password, or just a URL that could be connected into the Google Maps system.
Y=Folder access key that contains: the buyer's email address, buyer's SCP IMEI, buyer's PIN, and a Password (refer to the CS definition for a better understanding of these keys).

### FIELD OF THE INVENTION

The present invention relates to cashless payment systems. Also, in particular, the present invention refers to wireless payments to vending machines.

### BACKGROUND OF THE INVENTION

At the end of 2010, there were more than 6.9 million vending machines in the United States—the greatest number of any country in the world.

Coin fraud is an issue with vending machines, particularly mechanical vending machines. This involves the use of coins of foreign currency, or, in more extreme cases, worthless tokens or washers (commonly referred to as slugs), which have the same size and shape as the coin accepted by the machine. This is done to pay less for merchandise, and sometimes in order to get change that has more value than the originally inserted object.

In the United States, most vending machines have advanced, although expensive, currency detection techniques that can discern coins by reading the coins' “magnetic signature;” thus, many American vending machines will not take coins from other countries, even if their sizes are similar.

According to Michael Kasavana, National Automatic Merchandising Association at Michigan State University, the advent of reliable, affordable wireless technology has made telemetry practical and provided the medium through which cashless payments can be authenticated. Research shows that 50% of consumers will not purchase from a vending machine if its “Use exact change only” indicator light is on. Machines with telemetry can transmit sales and inventory data to a route truck in the parking lot so that the driver knows what products to bring in for restocking. Or the data can be transmitted to a remote headquarters for use in scheduling a route stop, detecting component failure, or verifying collection information.

Coke's North American vending fleet—which dispenses an average of 15 beverages per second—will include 100,000 Apple Pay-enabled machines by the end of 2015. That, according to Coke's global group director for mobile, makes Coca-Cola one of the largest retail acceptors of Apple Pay.

The Apple Pay mobile payment platform, introduced in October, allows iPhone users to pay for products easily and securely with their iPhone 6, iPhone 6 Plus, or connected Apple Watch (which begins shipping on April 24) at enabled payment terminals.

“Apple Pay is forever changing the way we pay for things,” Apple CEO Tim Cook said today at the company's “Spring Forward” media event in San Francisco.

Thus, 1.5% of the VMs in the U.S. accept Apple Pay by the end of 2015, and those VMs needed to be online to work.

### BRIEF DESCRIPTION OF THE PRESENT INVENTION

The present invention makes VM or VC using nearby SCP and CS to be operational without cash, and the CS keeps real-time VM inventory using the buyer's SCP to subtract one to the product paid by or delivered to the buyer. To restock a VM or VC inventory, a person using a SCP retrieves from the CS information about how many products were sold or how many products remained in the desired VM or VC kitchens.

To purchase a product, a buyer using a SCP turns ON the SCP GPS to locate the nearest VM or VC by retrieving the VM(X) folder from the CS, where X is the buyer's GPS location modified to retrieve all nearby VM(X) folders around that location; the VM(X) folder containing the product's availability, historical data, and the product's delivery temperature, that is to be displayed on the buyer's SCP screen; when walking to the VM or VC to purchase; and obtaining the product and/or service desired. The buyer could select from pictures or video of products, pictures of currency, or pressing a button displayed on the buyer's SCP screen.

To purchase Alcohol or Tobacco products, the buyer should have registered a driver license picture and entered a Personal Identification Number (PIN), and stored them in the buyer's Balance folder BB(Y) in the CS. Then, at the time of purchase, the buyer's SCP takes a facial picture and communicates it to the seller's SCP to validate the face with the stored information in the CS before the buyer's SCP can instruct the VM to dispense the law-restricted product.

The present invention can improve the VM industry by eliminating the telemetry needed, simplifying their payment and payment collection process, inventory process, pricing process, and saving thousands of operating dollars per year by reducing the VM cost.

A low cost Bluetooth Low Energy (BLE) electronic circuit, mentioned in this invention as an example of many similar components in the market, could replace bill/coin accepting mechanisms, as well as cash dispensers and all other electronics required to collect the product's price.

The present invention improves the buyer's experience to a new, improved level, and could be used to purchase other products and/or services, such as: food court's offerings, open gates, toll barriers, car washes, gas pumps, Redbox (DVD rentals), parking meters, multi-space meters, coin converters, coin operated water/electricity meters, coin laundry machines, etc. This can be done in addition to coin: cash, air, water, ice, ice-cream, candy, gum, pencils, pop-corn, beer, coffee, tickets, Metro tickets, newspapers, dispensers, etc. Also, the present invention allows modifying the product's price according to: expiration date, calendar, and/or product availability and historic demand.

The present invention allows machines without telemetry to keep inventory data available to the route truck driver's SCP at any place, so that the driver knows what products to bring in for restocking. Remote headquarters can access VM data for use in scheduling a route stop, detecting component failure, and/or to read operators' notes. More specifically, this invention simplifies a vending machine by replacing all electronics (i.e., displays, buttons and coin, bills, credit card, and NFC acceptors, as well as coin and bill dispensers) for an inexpensive radio controlled board.

The present invention could be tailored for large VM owners like The Coca-Cola Company or PepsiCo and for large food vendors like McDonald's, Wendy's, WHATABURGER and others with just an App in their names that contains their products' information and the buyer's balance for purchases, the App could expire when the balance is gone unless it receives more funds. An encrypted VM(X) folder, as well as the BB(Y) folder, could be part of the App's code to perform the same Buyer's functionality described in this invention, but without access to the CS. When the BB(Y) funds are used, the owner of the App could provide an ENP to the buyer that wants to deposit more funds in their App to continue using it. The App increases the available funds after the user enters the ENP by hand, or when the App reads the ENP within a text or email.

Also, the present invention improves the fast food industry; for example, allowing a food truck chef to use a SCP to set product prices and inventory levels every day, and to offer for sale only what is available, cook dishes already paid, send an email to the Buyer when the food is ready for pick-up, and dispense the product to the Buyer that their SCP proves has paid for it.

Provides the following advantages for the buyers; no cash is needed to purchase only an SCP, locate a VM or VC nearby, its product's availability, and its product's prices, alcohol, Tobacco, and other law-restricted products could be available, also obtain the product's temperature before purchase, and keep past purchase records.

Provides the following advantages for sellers; less expensive to maintain without cash mechanisms, cash gatherings, telemetry monthly fees, and sales' proceeds immediately available when they occur.

### DRAWINGS

FIG. 1 to FIG. 26 Attached.

### BRIEF DESCRIPTION OF THE DRAWINGS

The present invention could be explained by the following illustrations:

FIG. 0 A system using WordPress web sites to sell products from offline Vending Machines.

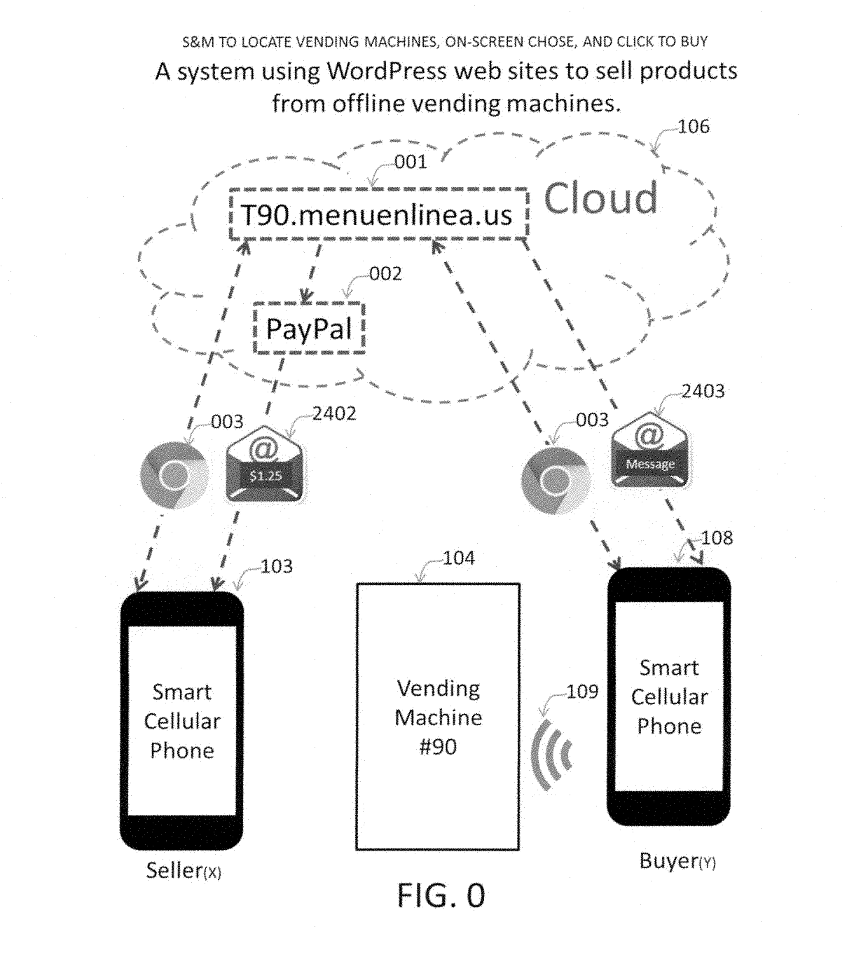

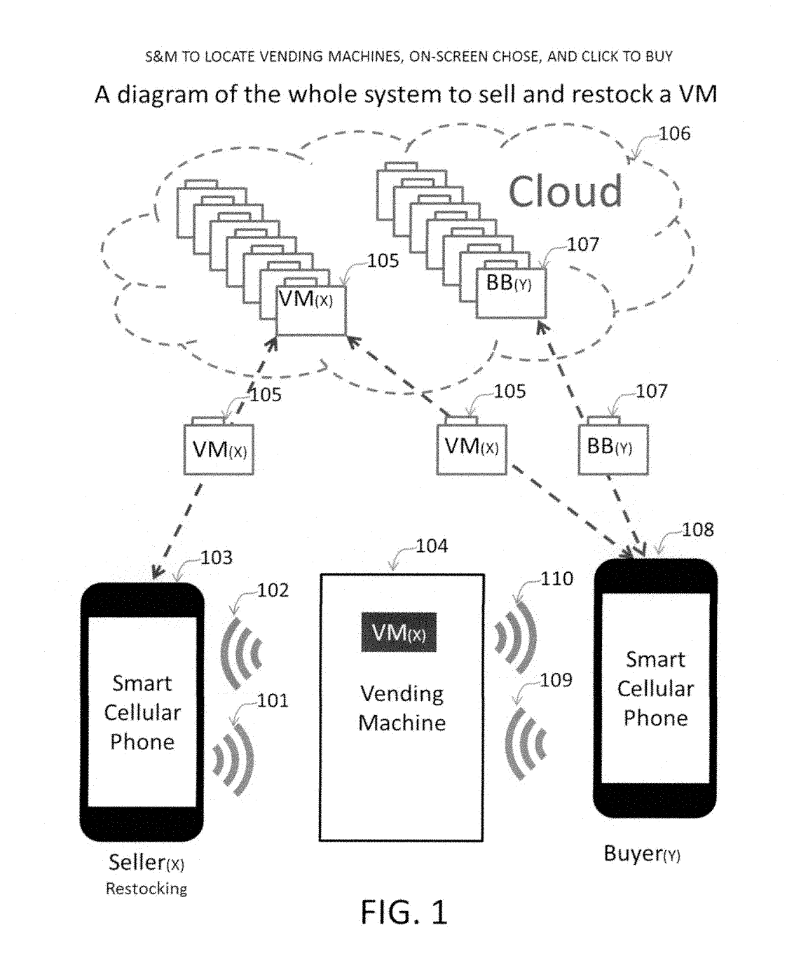

FIG. 1 A diagram of the whole system to sell and restock a VM.

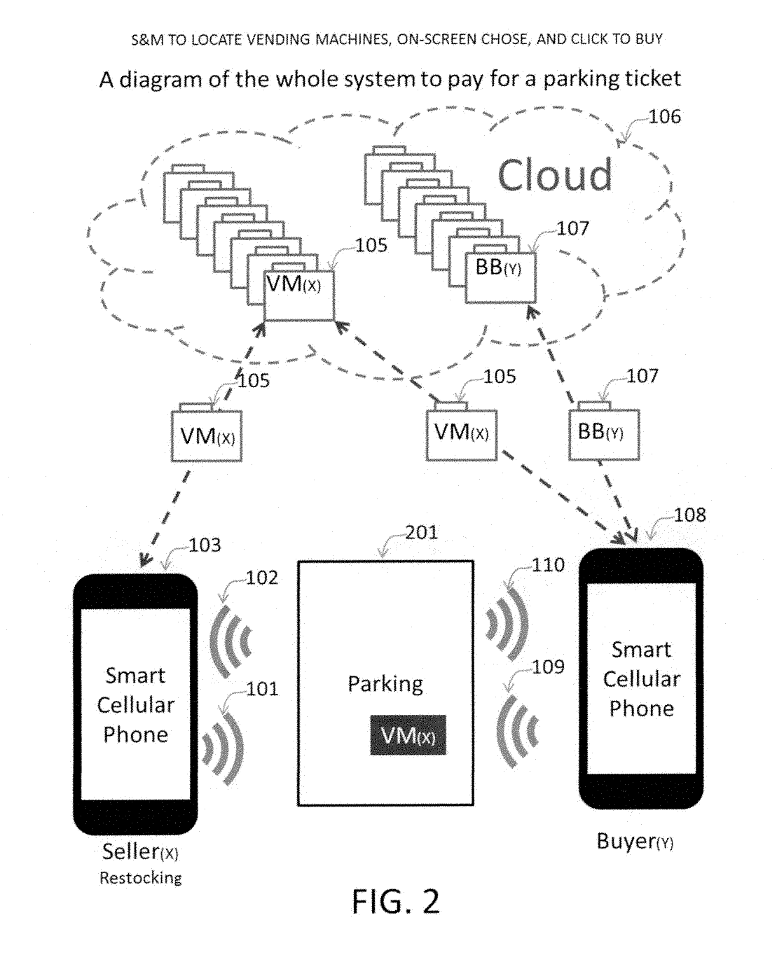

FIG. 2 A diagram of the whole system to pay for a parking ticket.

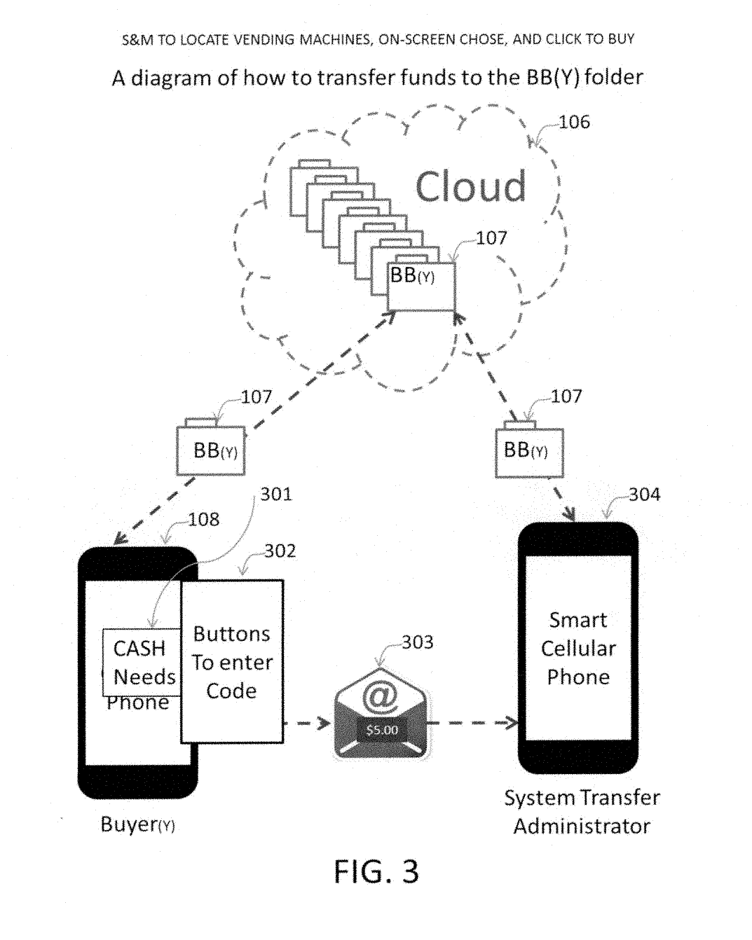

FIG. 3 A diagram of how to transfer funds to the BB(Y) folder.

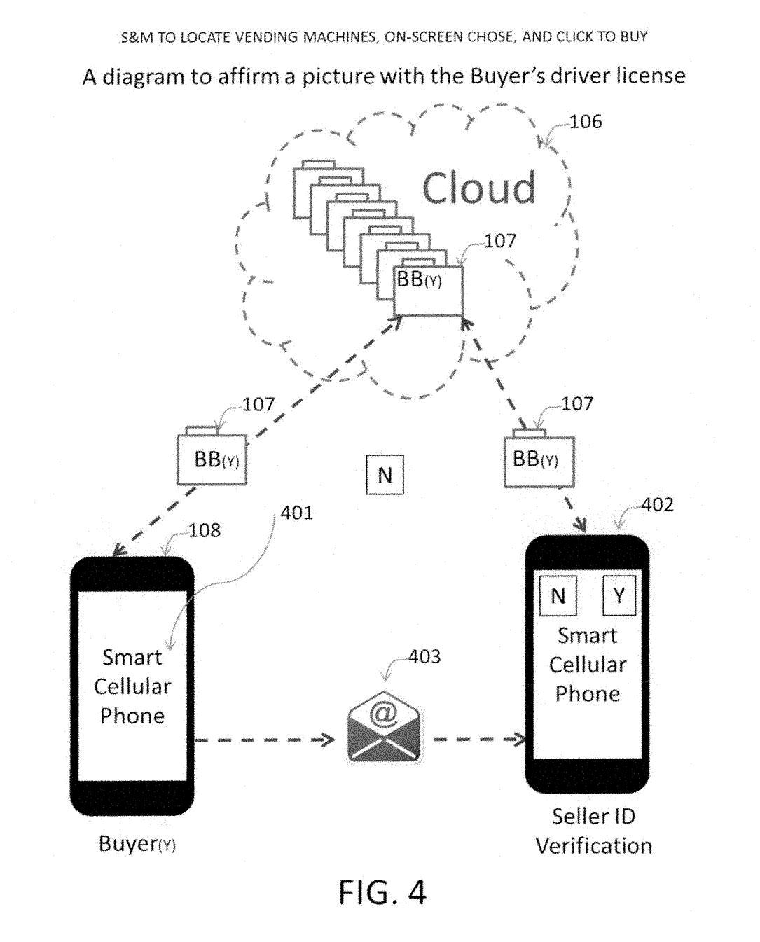

FIG. 4 A diagram to affirm a picture with the buyer's driver license.

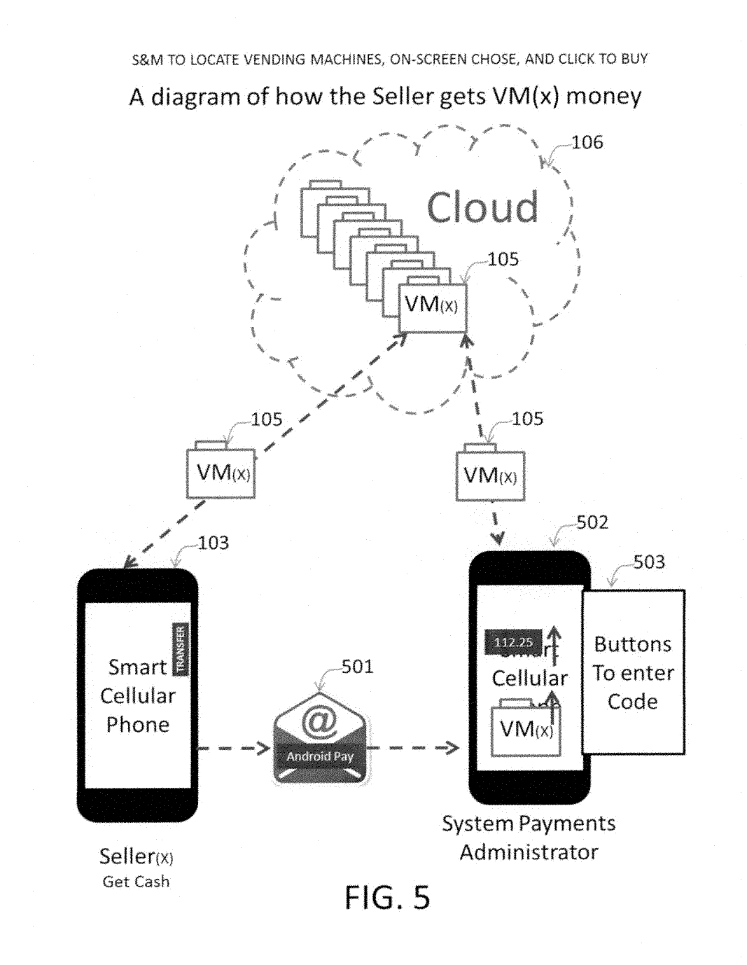

FIG. 5 A diagram of how the seller gets VM(X) money.

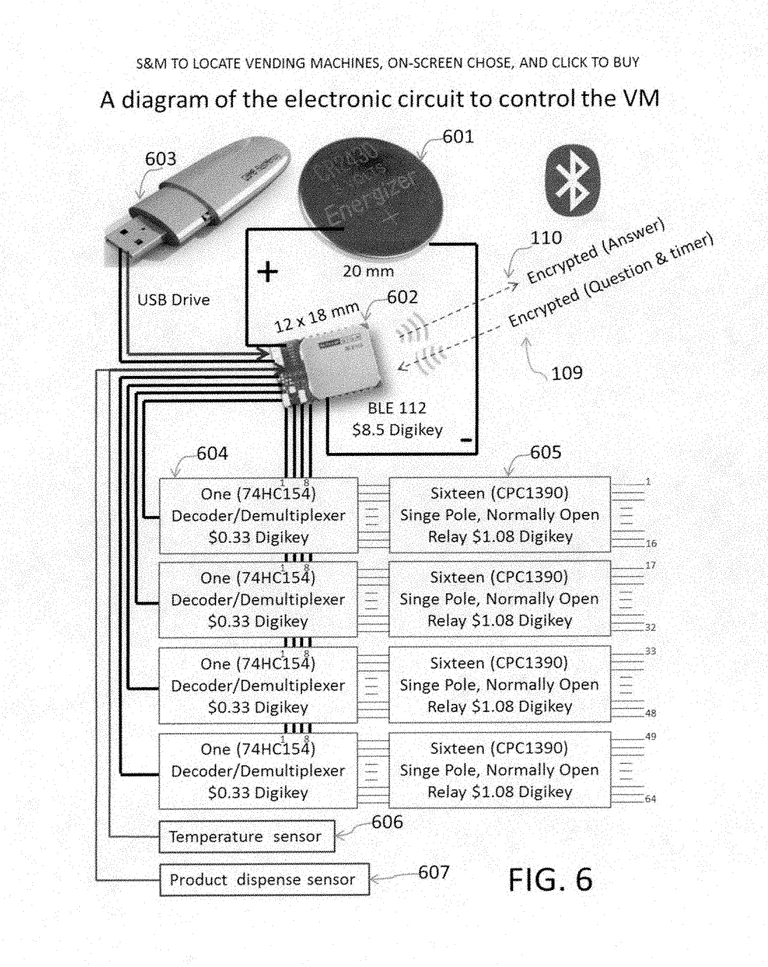

FIG. 6 A diagram of the electronic circuit to control the VM.

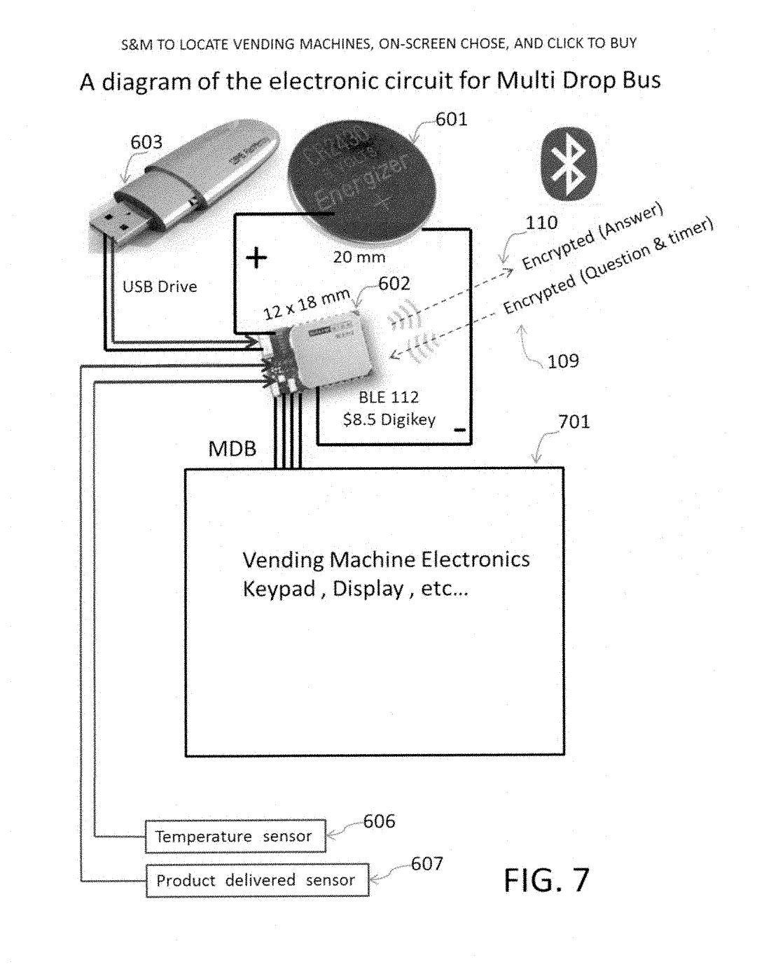

FIG. 7 A diagram of the electronic circuit for Multi Drop Bus.

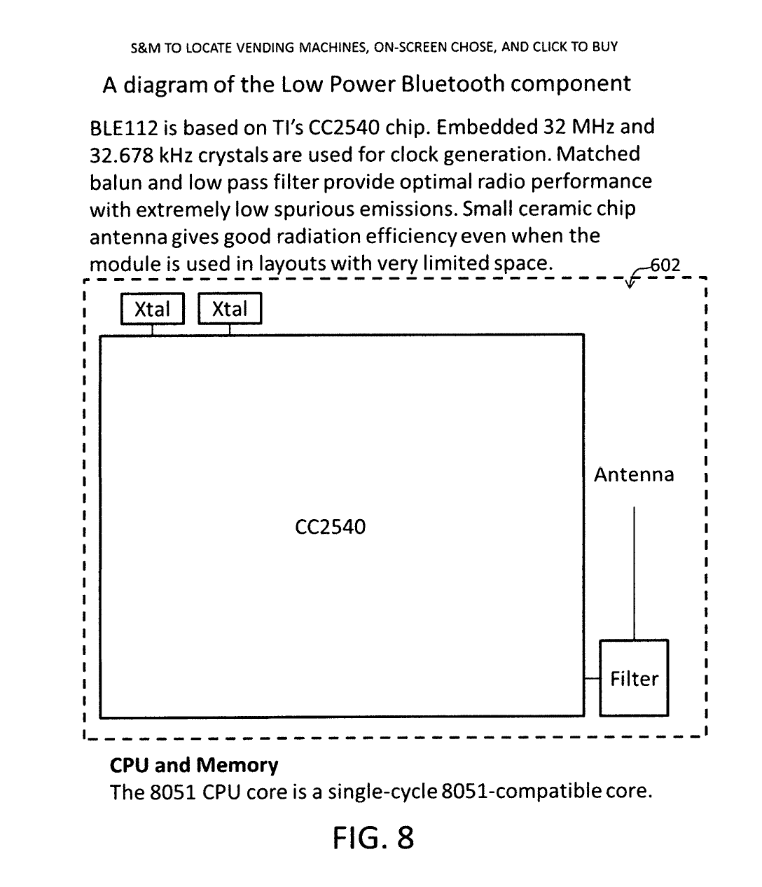

FIG. 8 A diagram of the Low Power Bluetooth component.

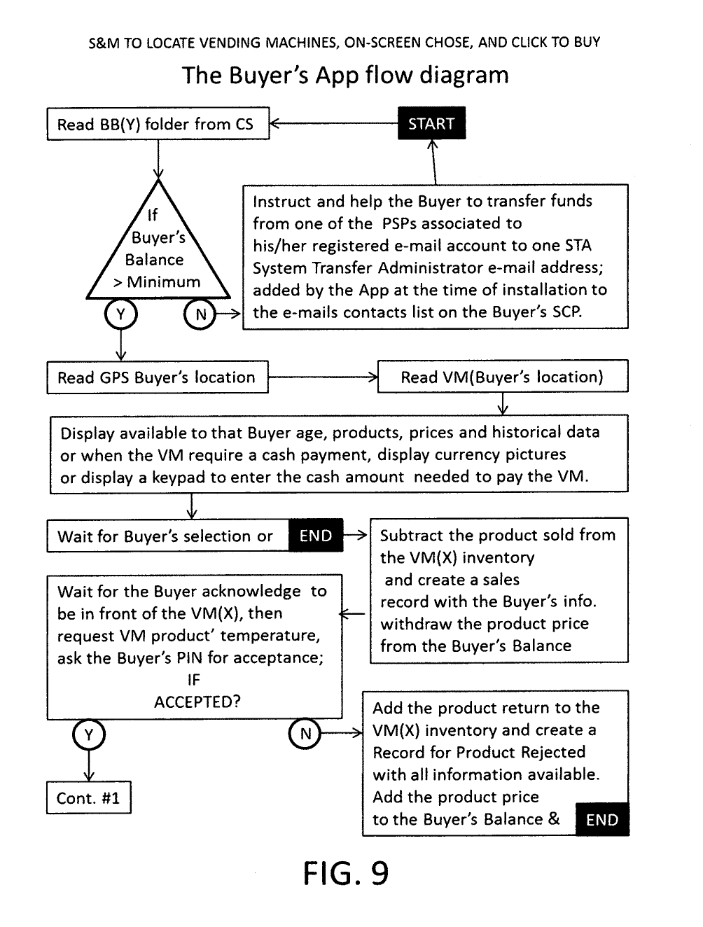

FIG. 9 The buyer's App flow diagram.

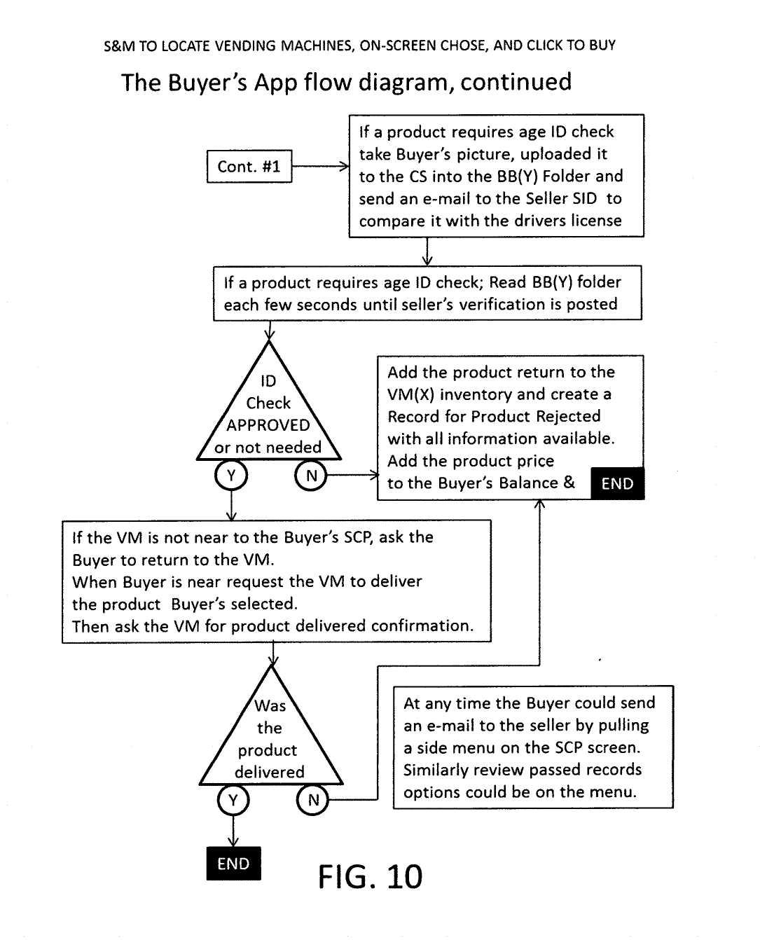

FIG. 10 The buyer's App flow diagram, continued.

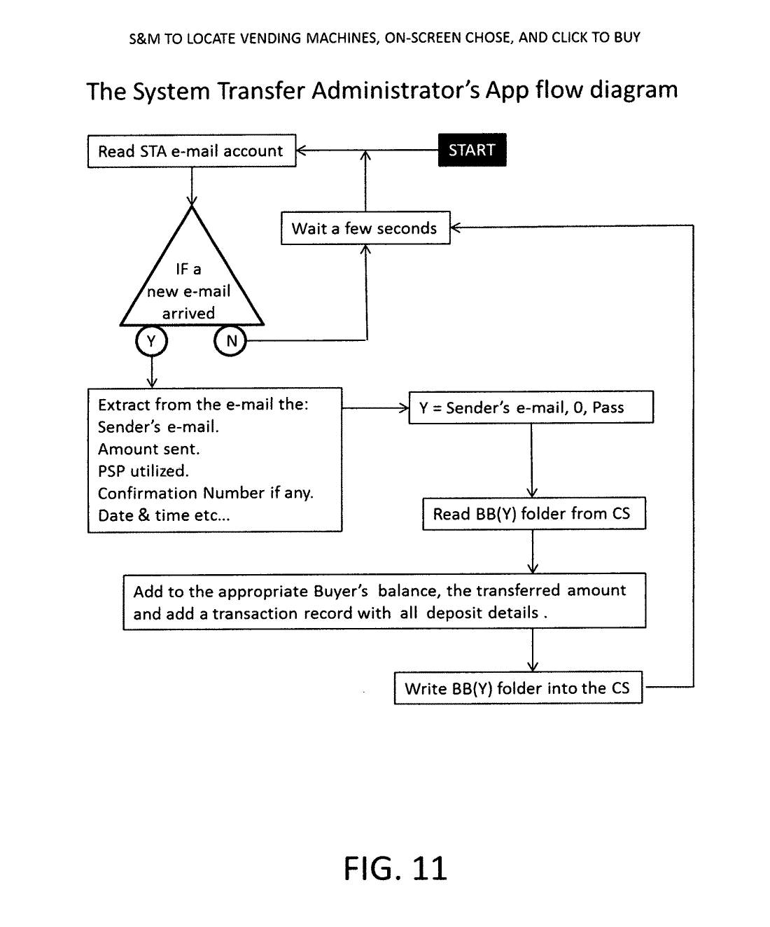

FIG. 11 The System Transfer Administrator's App flow diagram.

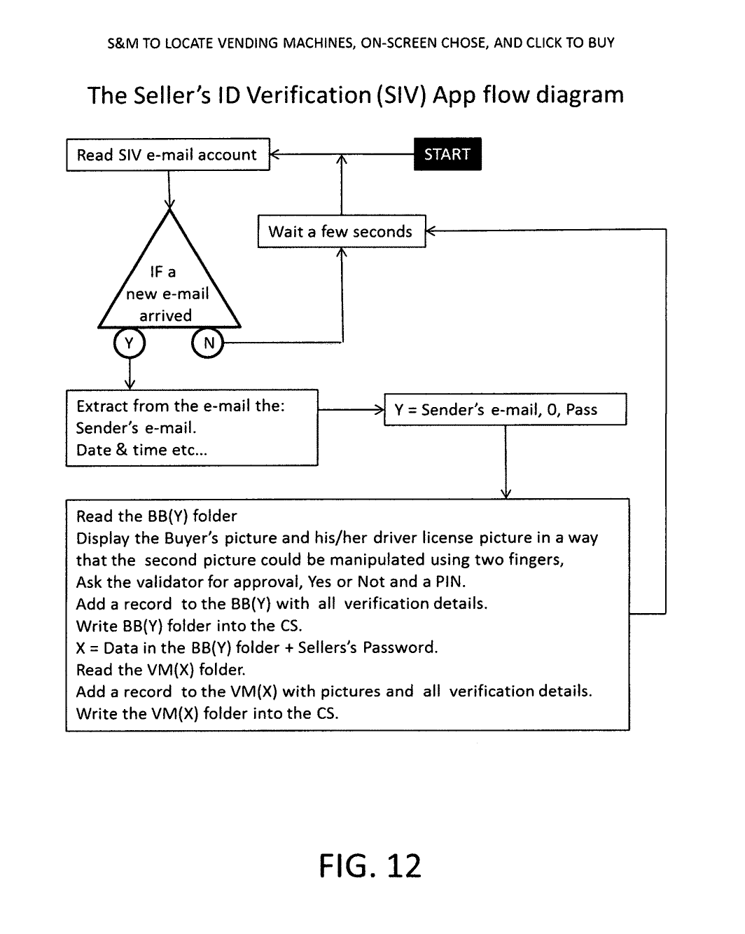

FIG. 12 The seller's ID Verification App flow diagram.

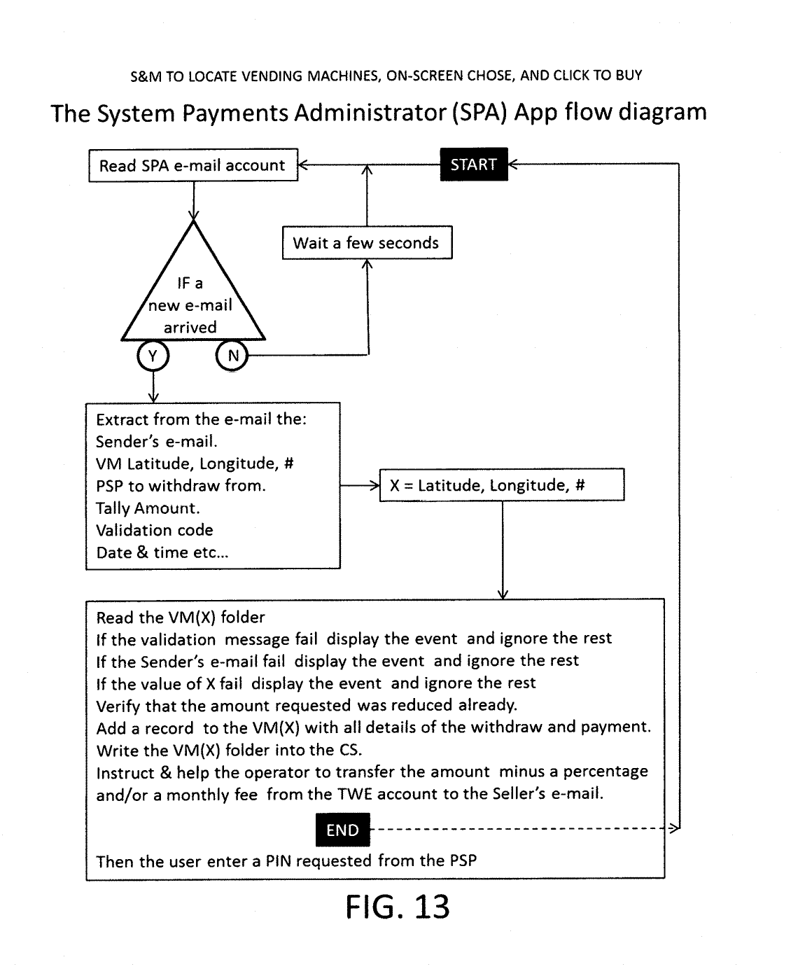

FIG. 13 The System Payments Administrator App flow diagram.

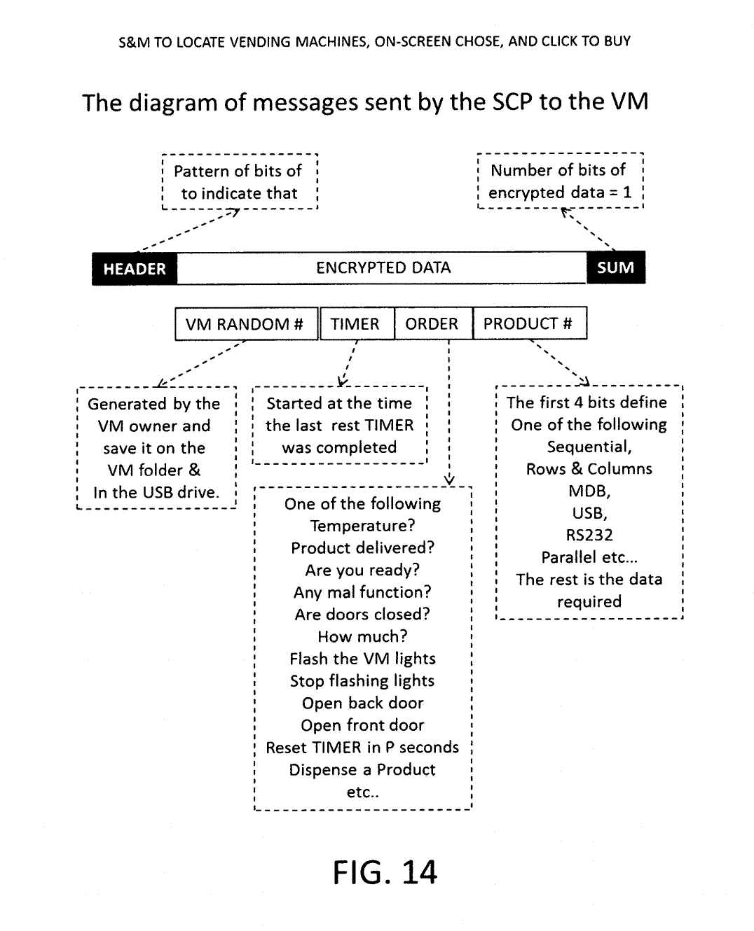

FIG. 14 The diagram of messages sent by the SCP to the VM.

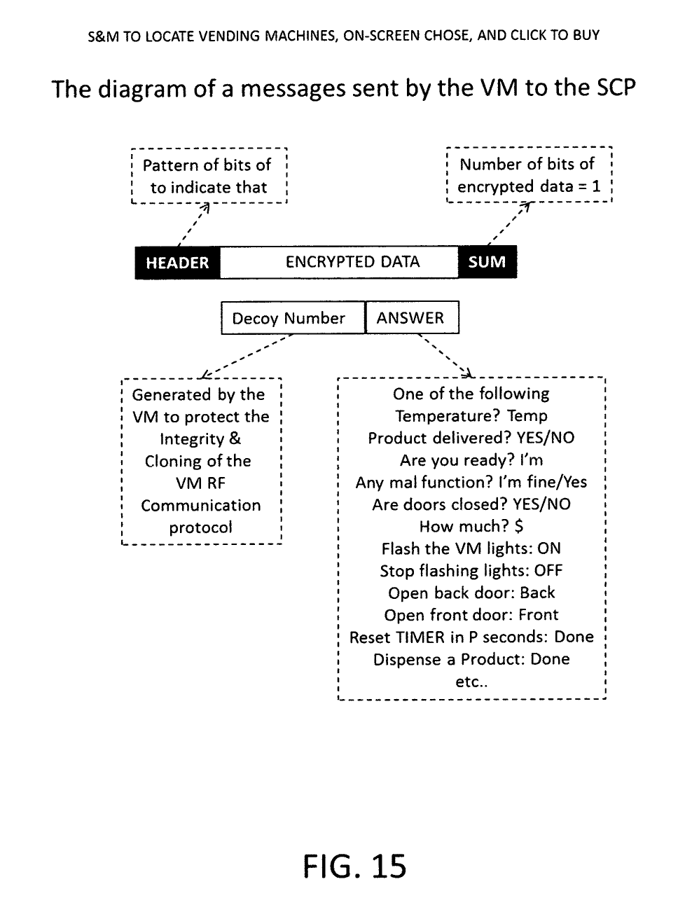

FIG. 15 The diagram of messages sent by the VM to the SCP.

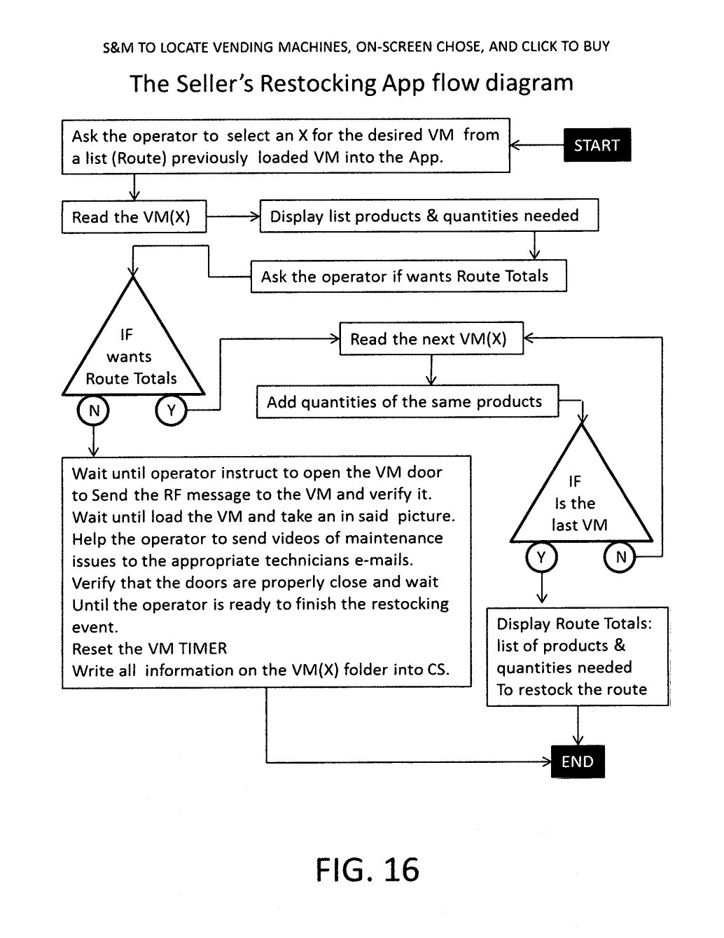

FIG. 16 The seller's Restocking App flow diagram.

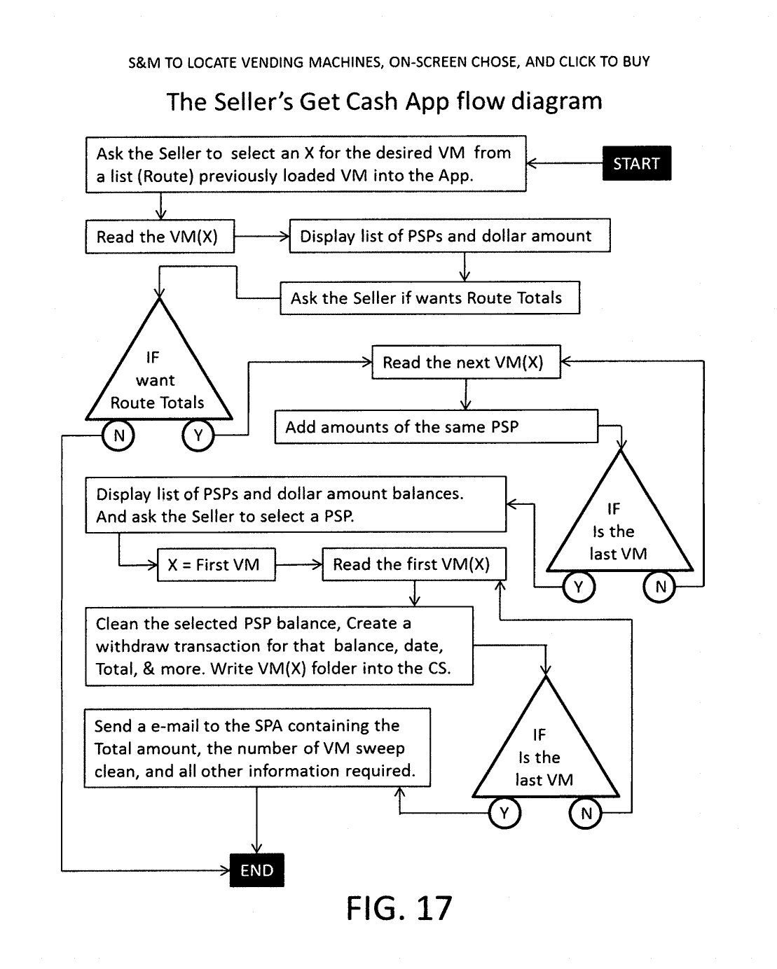

FIG. 17 The seller's Get Cash App flow diagram.

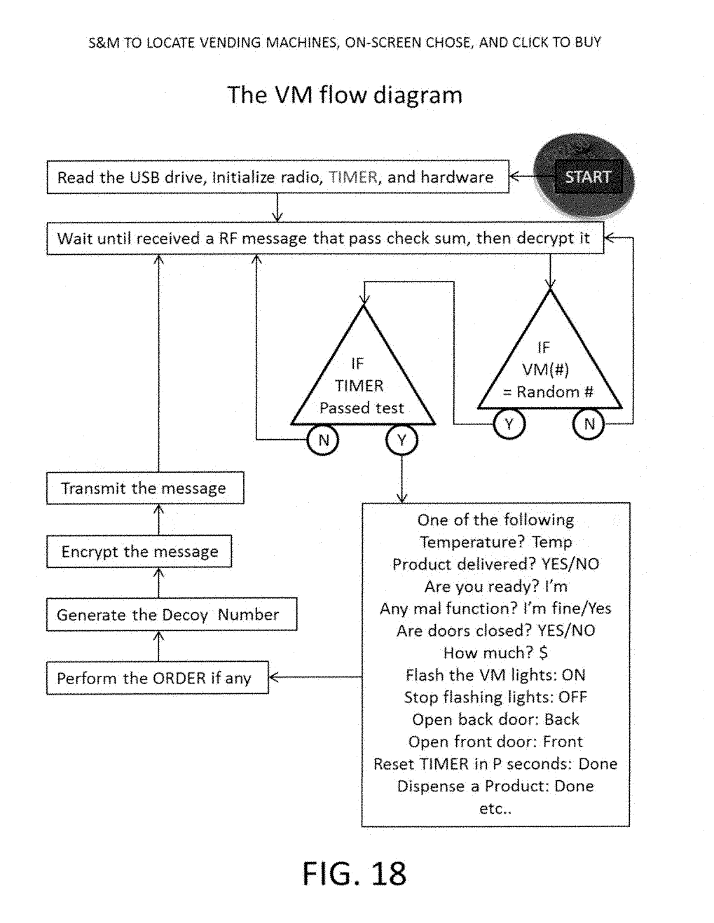

FIG. 18 The VM flow diagram.

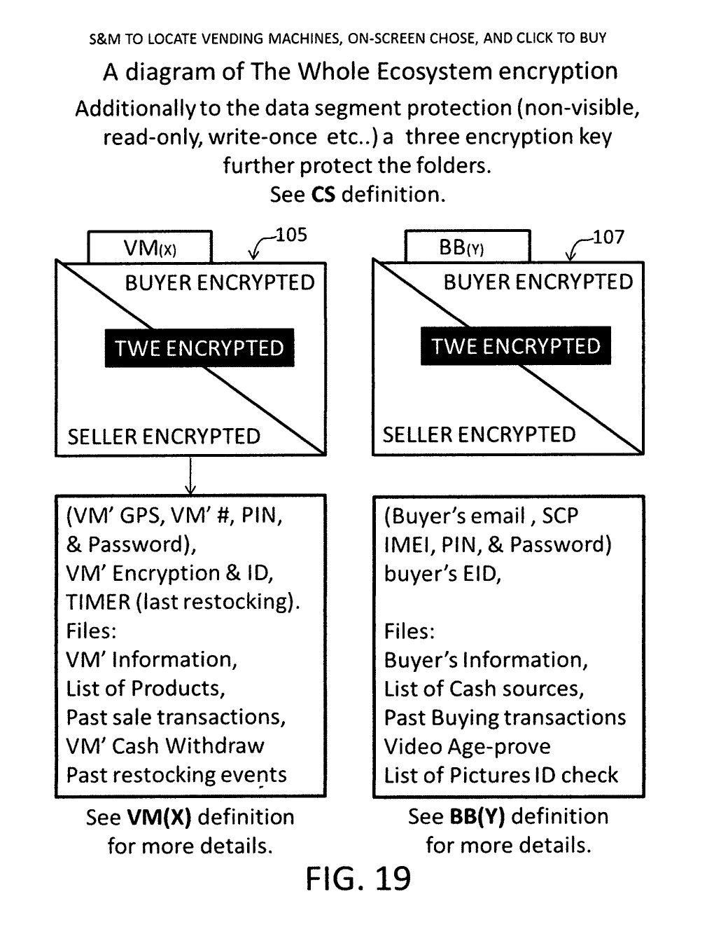

FIG. 19 A diagram of The Whole Ecosystem encryption.

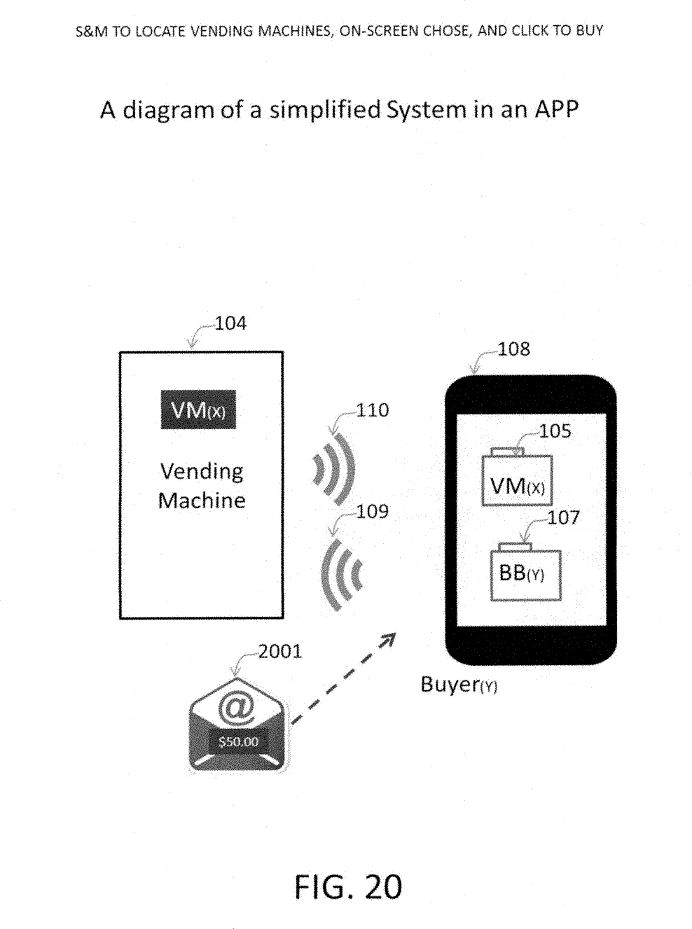

FIG. 20 A diagram of a simplified system in an App.

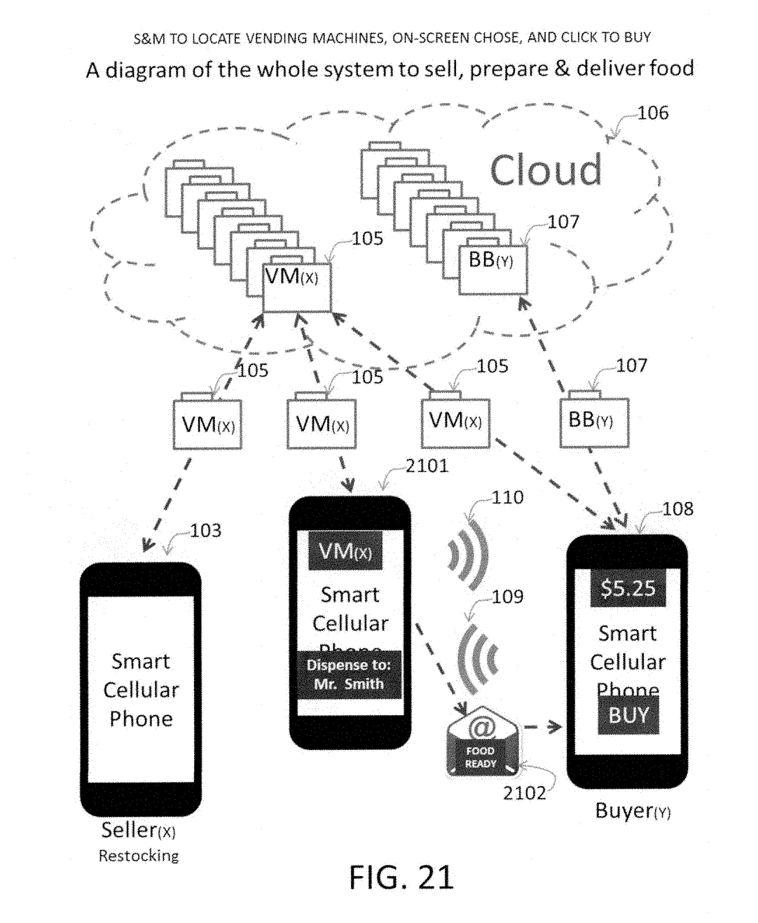

FIG. 21 A diagram of the whole system to sell, prepare, and deliver food.

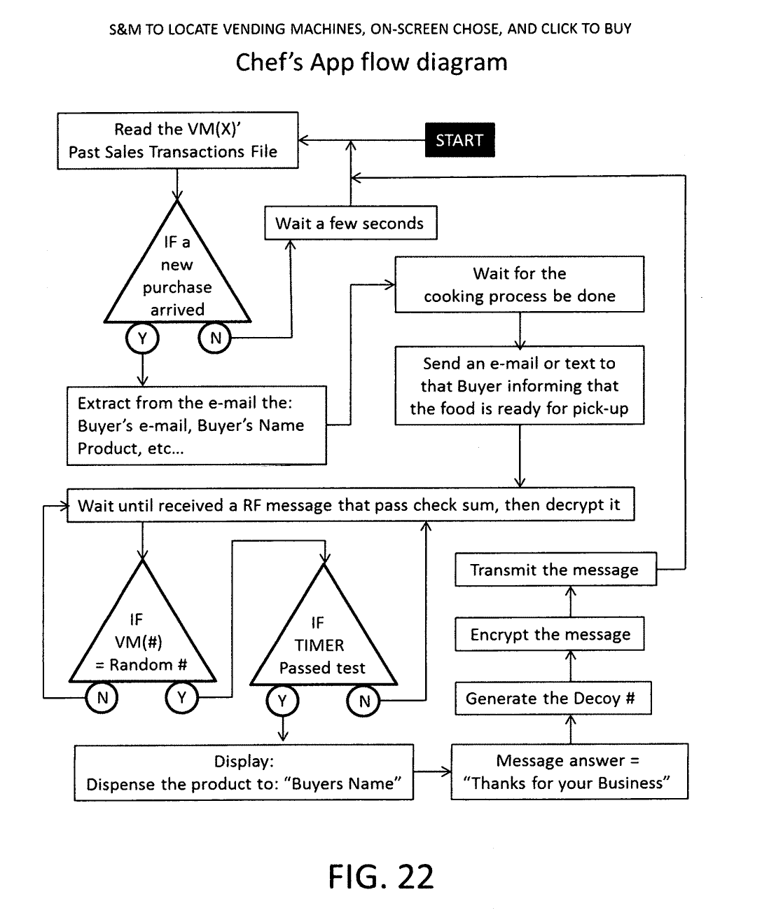

FIG. 22 Chef's App flow diagram.

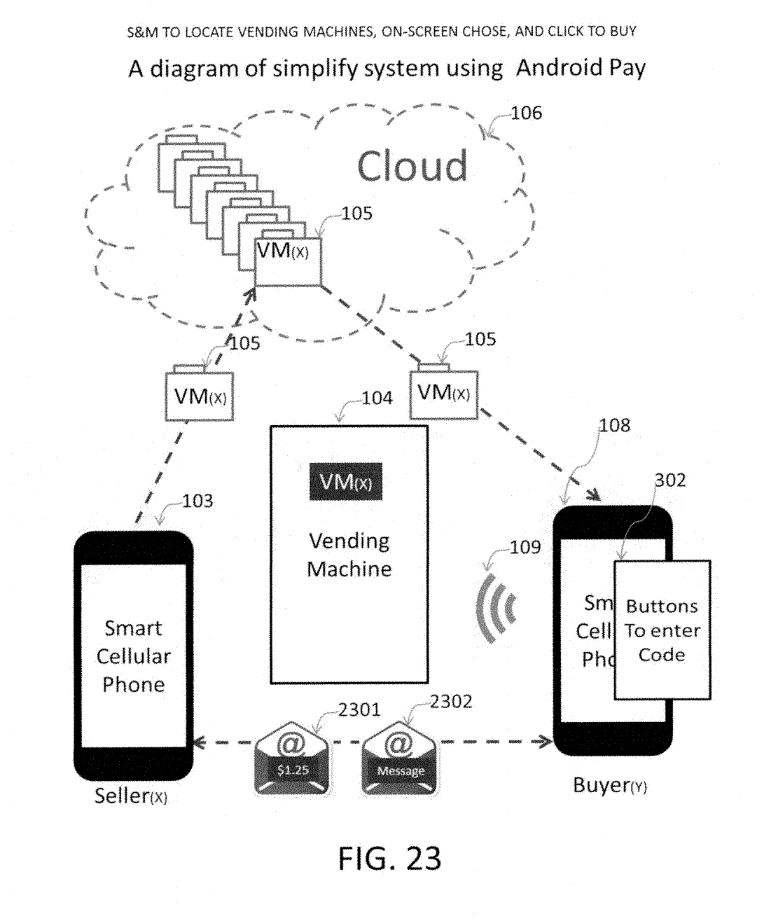

FIG. 23 A diagram of a simplified system using Android Pay.

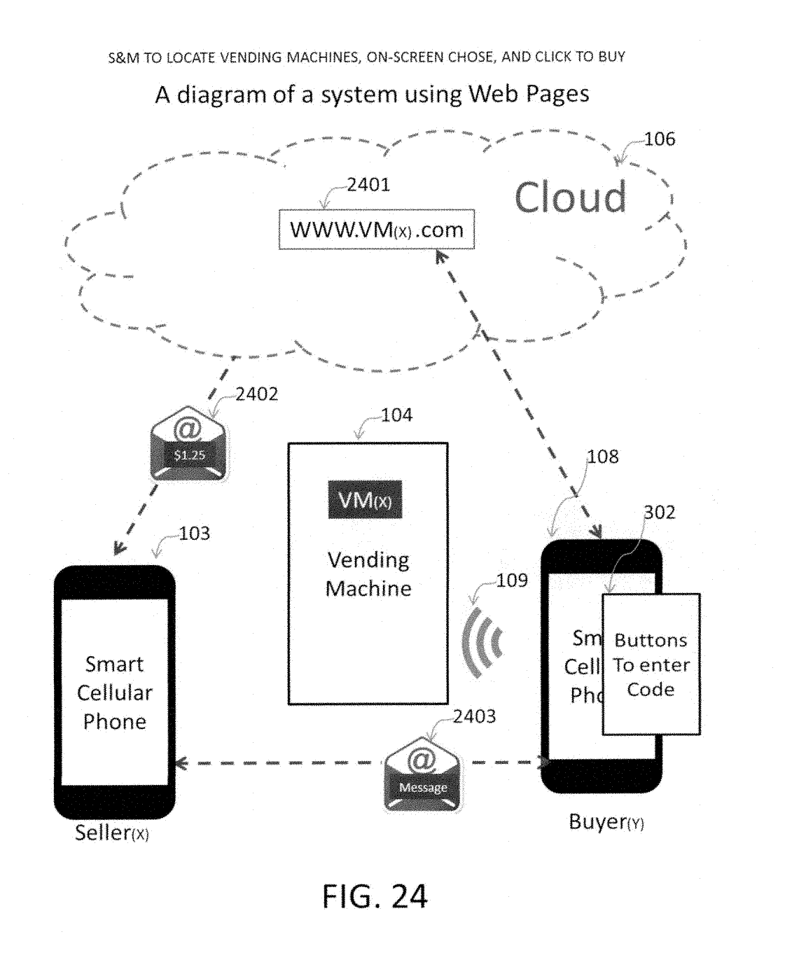

FIG. 24 A diagram of a system using Web Pages.

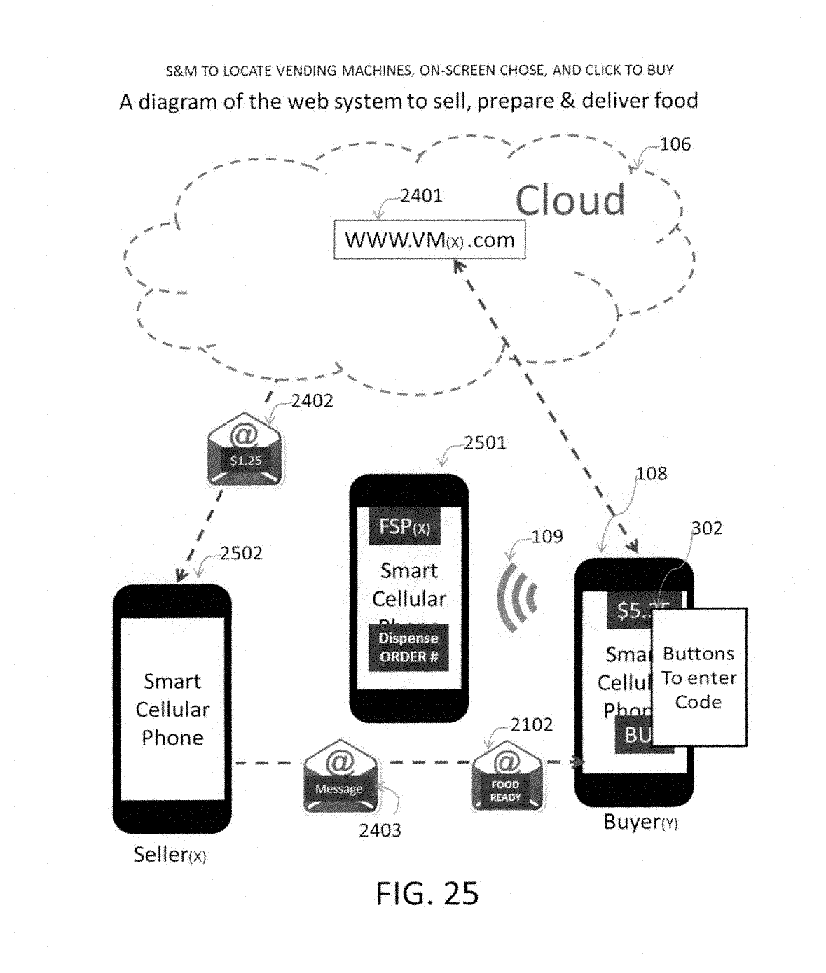

FIG. 25 A diagram of the web system to sell, prepare, and deliver food.

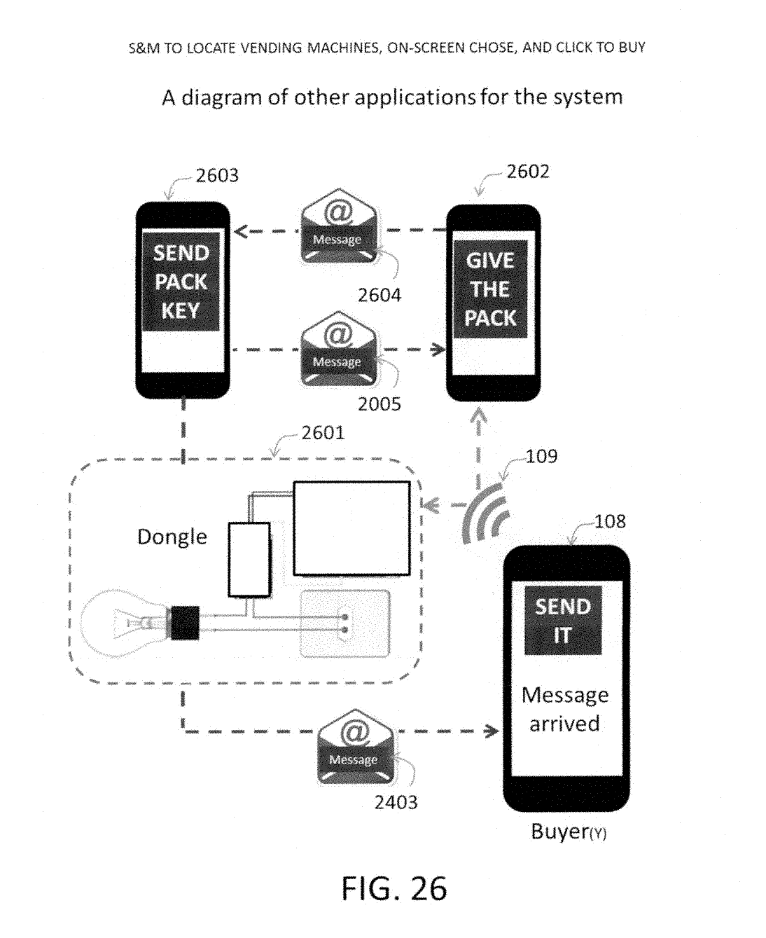

FIG. 26 A diagram of other applications for the system.

### DETAILED DESCRIPTION OF THE INVENTION

FIG. 0 illustrates a system in accordance with the present invention using one copy of the famous WordPress software for each offline VM 104. Each WordPress could be accessed using an address 001 from any SCP 108 using any web browser like Chrome 103. A buyer using Google Maps App running inside a SCP 108 searches for vending machines nearby, selects the desired one and clicks on it, to find its location and by clicking in the web site link, presented by the Google Maps App reaches the WordPress address 001 that belongs to that particular VM 104. Then the buyer selects the products and clicks to pay, said WordPress software handling that site will transfer the order to PayPal 002 which will transfer the purchase amount to the sellers PayPal account and send the payment email confirmation 2402 to the seller SCP 103, also the said WordPress software sends the email 2403 to the buyer's email account. The buyer SCP 108 running an App designed to read the email 2403 and to create and transmit the message 109 to the VM 104 requesting the delivery of the products purchased. The adapter module 602 installed in the VM 104 receives said message 109 and dispenses the products.

FIG. 1 illustrates a generalized system in accordance with the present invention. A buyer using a SCP 108 uses its GPS location to retrieve one or more VM(X) folder 105 from the Cloud 106, and then the buyer selects the VM(X) folder that corresponds to the nearest VM 104. The buyer could be miles away from the real VM 104, but on the SCP 108 screen, the buyer can review one-by-one all the products offered by the VM 104. To purchase a product, the SCP 108 reads all the balances stored in the BB(Y) folder 107. If there is enough balance, in more than one account the SCP 108 asks the buyer to select the account, then extracts the price amount from that balance and generates a transaction record in both folders BB(Y) 107 and VM(X) folder 105, and also reduces the inventory of that particular product sold in the VM(X) folder 105. When the buyer locates the VM 104, the SCP 108 transmits a radio frequency message 109 asking the VM for the temperature of the product, and receives an answer back from the VM 104 through the RF signal 110. If the buyer accepts it by a click on the SCP screen, the VM 104 dispenses the product. In the event that the buyer rejects the product, the SCP 108 returns the money back, adds the product to the inventory again, and creates another transaction record indicating that event, saving the event in the two folders.

For restocking the VM 104, the seller's restocking truck operator using the SCP 103 enters a GPS location to retrieve from the CS 106 the VM(X) folders 105 of that VM 104 attached to that location, reviews the inventory of that VM 104 while sitting in the truck, then prepares the restocking product, and walks to the VM 104. When the SCP is near to the VM 104, the operator can click on the screen to instruct the SCP 103 to transmit the RF message 101 to open either the VM 104 back or front door. See FIGS. 9, 10, and 16 for a better understanding of the process.

FIG. 2 also illustrates a generalized system in accordance with the present invention, when instead of being a product it is a service; for example, when it is a parking space in a building. The buyer experience is very similar to the description of FIG. 1. One of the differences is that the buyer, instead of selecting a product on SCP 108, will select a currency's picture, receive the amount from the VM 104, or enter the desired amount on a screen keypad to pay the amount the VM 104 is asking to allow the car to exit the building. Another difference is that the buyer cannot purchase the space in advance, but could learn how many spaces are available on each floor before taking the ticket in the desired section of the building. Another difference is that the restocking is just restocking of data, such as parking space available. For restocking: the restocking operator could receive on the SCP 103 an email from the buyer's SCP 108 that, instead of dispensing the product, sends an email. Then, the SCP 103 receives that email and increases the inventory in the VM(X) folder accordingly with the information sent in that mentioned email. See FIGS. 9, 10, and 16 for a better understanding of the process.

FIG. 3 illustrates how the buyer increases his/her available balance for purchases. The buyer's SCP 108 displays the need for cash at the middle of a purchase transaction, or at any time the buyer retrieves the balance. The buyer's SCP 108 could initialize and launch the PSP App to send money to the STA 304 by email 303, the PSP App requires that the buyer enter a PIN 302 before confirming the funds transfer. The SCP 304 reads the STA's email and extracts the amount and the buyer's email address from it, that data is needed to retrieve and modify the buyer's BB(Y) folder 107. This process modifies the BB(Y) folder adding to the balance the transferred funds, and creates a transaction record for book keeping. See flow diagram in the FIG. 11 for a better understanding of the process.

FIG. 4 illustrates how the seller could affirm the buyer's age before allowing a VM to dispense a law-restricted product. To be allowed to purchase law-restricted products, a buyer should request verification from the seller before his/her SCP 108 offers law-restricted products. By entering a picture of his/her driver license, a buyer initiates that validation process by sending an email to the SIV, who will video call the buyer to ask questions and record the video for future government verification in the BB(Y) folder 107. That video should show the buyer holding his/her drivers' license in one hand in a way that the SIV can verify that it is the same person on the initially stored driver license. Only if the SIV verifies the age of the buyer will the SCP 108 offer law-restricted products. The SCP 108 screen shows the face picture 401 of the person that entered the correct PIN to instruct the VM to dispense the product. Before the SCP 108 does that, it sends an email 403 to the SIV SCP 402, which is continuously waiting for emails to arrive. When one arrives the SCP 402 extracts the buyer's email address and uses it to retrieve the BB(Y) folder from the CS 106, containing the buyer's information including the picture 401 and the buyer's driver license to compare. The SIV should manipulate using two fingers the driver license picture to facilitate the verification decision to write a Yes or NO answer in the BB(Y) folder 107. The SIV should enter a PIN before storing the modified BB(Y) folder 107 in the CS folder 106. See flow diagrams FIGS. 9, 10, and 12 for a better understanding of the process.

FIG. 5 illustrates how a seller gets cash out of the system. The seller's SCP 103 could display at any moment each PSP balance, or all together by simply retrieving and tallying each of the VM(X) folders created by that seller (entered into the SCP 103 at the initialization process of the App). The seller could select one PSP to sweep that balance clean. After that selection, the SCP 103 should clean each of the balances one-by-one, creating a transaction record for book keeping, and store a randomly generated validation code on each VM(X) 105. Then, the SCP 103 will send an email to the SPA 502 containing: VM latitude, longitude, number, PSP to withdraw from, tally amount, the validation code, date and time, etc. The SCP 502 is continuously waiting for emails to arrive. When one email arrives, the SCP 502 extracts from the seller's email the address (latitude, longitude, and number) to retrieve the VM(X) folder to verify the information sent, and will process the payment only if everything is correct. In that event: the SCP 502 adds a record to, at least in the last, VM(X) 105 with all details of the withdrawal and payment; initializes and launches the PSP App to complete the payment transaction; and finally the PSP requests the SPA's PIN on the screen 503. See the flow diagram FIG. 13 for a better understanding of the process.

FIG. 6 illustrates the components of one possible electronic circuit to operate the VM. The battery 601 keeps the computer module (BLE 112) 602 able to maintain a TIMER circuit inside, working even when the power of the VM is gone. That TIMER is a critical component in the security of the system. The USB drive 603 provides a friendly way to write and transfer the initial configuration and security values required. Each of the integrated circuits 604 allows the computer module 602 to activate one of the sixteen solid state relays 605 associated with each one of them, allowing to serve from very small to very large VMs. The temperature sensor 606 allows the computer module 602 to know the temperature of the VM and to communicate it to a SCP using the radio transmitter built inside the computer module 602. Similarly, the product dispense sensor 607 allows the computer module 602 to learn and communicate that information to the SCP 108.

FIG. 7 illustrates the components of another possible electronic circuit to operate the VM. The picture 701 is the picture of the internal components of a VM that accepts MDB communication. The computer module 602 could mimic the MDB protocol to interface with VM as another payment source, without reducing the benefits to buyers and sellers offered by this invention.

FIG. 8 illustrates a picture of the internal components of the very popular computer module 602.

FIG. 9 illustrates the flow diagram of the App used by the buyer's SCP 108 to allow the buyer to purchase products and services from the VM.

FIG. 10 Illustrates the continuation of the flow diagram of the App used by the buyer's SCP 108 to purchase products and services from the VM.

FIG. 11 illustrates the flow diagram of the App used by the STA's SCP to transfer funds from very popular PSPs to TWE funds to purchase products and services from the VM. See FIG. 3 for a better understanding of the process.

FIG. 12 illustrates the flow diagram of the App used by the SIV's SCP to verify the identity of the person that wants to have a law-restricted product. See FIG. 4 for a better understanding of the process.

FIG. 13 illustrates the flow diagram of the App used by the SPA's SCP to Tally and sweep clean the balance of a list of VM, and transfer the Tally to the seller's account with that PSP. See FIG. 5 for a better understanding of the process.

FIG. 14 illustrates the format of the radio frequency message 101 or 109 transmitted by an SCP when trying to communicate with a VM or VC or SCP or special hardware. The digital format of the message could be a classic header, payload, and check sum. The payload portion of the message should be encrypted using an encryption key created by the seller and stored in the VM(X) folder or inside the buyer's device or inside the device that will send an email, and/or in the USB drive of the VM. Inside the encrypted message, the VM ID could be VC ID or SCP ID. To protect the cloning of the message, a running TIMER value could do the job. That can be accomplished by calculating the seconds passed from the last restocking event recorded in the VM(X) folder, to the moment that the SCP 108 transmits the message to the VM. Similarly in other environments can be accomplished by storing an event time inside the buyer's device or inside the device that will sent the email 2304. The rest of the message is easy to understand from the illustration.

FIG. 15 illustrates the format of the radio frequency message 102 or 110 transmitted by the VM 104 answering to the SCP question or order. The digital format of the message could be a classic header, payload, and check sum. The payload portion of the message should be encrypted using an encryption key that is created and stored in the VM(X) folder and in the USB drive by the owner of the VM. Inside the encrypted message is a Decoy Number generated by the VM 104 that could be the mix of the VM ID and the real timer value, to protect the integrity and cloning of the message, because it can be filtered by the SCP. See FIG. 18 for a better understanding of the process.

FIG. 16 illustrates the flow diagram of the App used by the seller's Restocking SCP to load the truck with the products needed in the whole Route as well as the products to unload from the truck on each stop of the Route. See FIGS. 1 and 2 for a better understanding of the process.

FIG. 17 illustrates the flow diagram of the App used by the seller's SCP to Get Cash out of TWE. Basically, TWE process keeps in each VM(X) folder a balance for each PSP. Each balance contains all sales pay with funds from that PSP; thus, the only way for TWE to return cash to the seller is by transferring from the funds received from that particular PSP the amount that buyers spent in VM paid with funds from that particular PSP. See FIG. 5 for a better understanding of the process.

FIG. 18 Illustrates the flow diagram of the circuit illustrated in FIGS. 6, 7, and 8. For security reasons, the process is just receiving radio frequency messages, analyzing them, and only acting if the message received is a valid one.

FIG. 19 Illustrates the TWE encryption process. Basically, each folder could contain segments of data that are not visible unless the App knows the encryption key. Because the buyer's App should access the two folders to read and write information related to the purchase, age verification, and transaction records for bookkeeping.

FIG. 20 Illustrates a simplified system assembled inside an App. Basically, some reduced set of information from the two folders BB(Y) 107 and VM(X) 105 could be included in the SCP 108, that can: expire after the balance has been used; or can be used in App purchase services; or can enter an ENP by other means; or can receive that purchase key by email 2001 or text, etc. A system like that can be for VM 104 owners that own large numbers of VM like The Coca-Cola Company or PepsiCo. A dedicated App for companies similar to the aforementioned but that will not be interested in offering alcohol or Tobacco products could use a simplified App that contains all their products and a way to make any of their VMs dispense their products. The communication with the VM includes a TIMER, that in the simplified version could be replaced in the SCP with a date inside the App, and in the VM the running TIMER could be set with the SCP of the person that restocks the VM or the one that changes the battery every five years or so.

FIG. 21 illustrates a diagram of the whole system to sell, prepare, and restock a food inventory in a very similar way as was described in FIG. 1, but now in a food court or similar facilities; thus, instead of using a VM 104, a SCP 2101 is depicted as a chef's tool to allow to know what to prepare by retrieving from the VM(X) folder a purchase record, or receiving the same information by email, text, or other means from the Buyer's App. From the VMs' folder Past Sales Transactions File, the SCP 2101 extracts the Buyer's email and product purchased then after the cooking process is done the SCP 2101 sends an email 2102 to that Buyer informing that the food is ready for pick-up. When the Buyer is close by and approves the product by sending the encrypted message 109, the chef then dispenses the product.

FIG. 22 illustrates the flow diagram of the App used by VC. The App is periodically retrieving from the VM(X) folder a purchase record in the Past Sales Transactions File to extract the Buyer's email, name, and purchased product. Then, after the cooking process is done, the App sends an email to that Buyer informing that the food is ready for pick-up. When the Buyer is close by and approves the product by sending the encrypted message, the chef then dispenses product.

FIG. 23 illustrates a simplified system that could achieve similar results, and could work without the Buyers folder and using read only VM(X) folders containing less information. Buyers with an electronic wallet account with one of the service providers, download an App created by that service provider that contains an API of that service provider. Buyers using SCP 108 running that App download VM(X) folder 105 using the buyer's GPS location as index (x) and use it to purchase a product from that VM(X) 104. The buyer's App using the electronic wallet service provider API asks the buyer for authorization 302, then sends an email to the seller requesting to deliver the product paid by the email identified buyer. The seller's SCP 103 running an App to accomplish that function, receives an email notification of the payment 2301 and replies with an encrypted email message 2302 that contains the required data described before. The Buyer's App receives the message contained in the email 2302, and uses it to calculate and transmit the command message that the VM(X) 104 required to receive and validate, before delivery of the product. Sellers just upload to the CS the VM(X)s folders with the data required by the electronic wallet service provider and the data required to sell the VM products, that VM folder could even be read only and only re-written by the seller's App that created it. The Seller's App could keep a record of all purchase as described before. Similarly, the VM(X) removable memory could keep a record of all transactions as described before. In this simplified version of the invention the Cloud Storage is just storage with restrictions on who can write on it. The seller's App could handle more than one VM(X) when the email 2301 contains the identity of the VM(X). The VM(X) folders could be encrypted using a Key known only by the App. Each VM(X) folder could contain an encryption Key known only by the seller to allow safe email communication of the seller's authorization message to the buyer's email that will be read by the buyer's App. An additional encryption key could be sent inside the seller's email message 2302 to the buyer to be used by the buyer's App to encrypt the command message to that particular VM.

FIG. 24 illustrates another simplified system that could achieve similar results, but now could work without the BB(Y) folder and without the VM(X) folders, this time using only a web page for each VM. First, the buyers open an account with Google Wallet or PayPal or other similar service provider, and then the buyers download the buyer's App, that will be running in the background of the SCP 108 reviewing for new emails or other forms of notification 2403 sent by seller's SCP 103.

To purchase products the buyer using SCP 108 opens the Google Maps App and looks for the VM(X)s nearby, selects one and clicks on the associate webpage, then the SCP 108 launches the Internet browser to show the Web page, inside that page the buyer selects the products that they wish to buy and click to buy one or a few of the desired items, as occur in any online store. Then, a new window from Google Wallet, PayPal or other service provider asking the buyer for an authorization 302 to pay for that transaction, after that a confirmation of the payment transaction could appear on the webpage screen and/or an email could be sent seconds later to the buyer. Then the buyer walks to the VM, during that time the buyer's App running in the background should detect an email 2403 from the sellers' App.

The buyer's App running in the SCP 108 reads the message 2403, decrypted to obtain all the required data described before in FIG. 14 plus transaction information. Then the buyer's App generates the command when the buyers push a button to instruct the VM to deliver the purchased goods one by one or transfer the total amount paid allowing the buyer to take the goods one by one, manipulating the VM selection panel. In the event that the VM fails to deliver the goods the buyer's App could cancel the transaction informing the seller and the payment service provider. At any time after that, the buyer could communicate (by email or perhaps by phone call) with the seller, because the sellers' information could be readable in the buyer's email.

The sellers' App running in the background of the SCP 103 is waiting to receive an email from Google Wallet, informing when a buyer places an order. Then the sellers' App finds and updates the inventory of that particular VM(X) inside the SCP 103 in the event that that seller operates more than one VM, then creates and sends the mentioned message 2403.

Obviously, each seller should open a Google Wallet account, create a URL site for each VM containing the list of items available in that particular VM, and set the VM (location, URL, hours of operation, etc.) on Google Maps or a similar service.

FIG. 25 illustrates another simplified system that could achieve similar results for the food sellers, but now could work without the BB(Y) folder and without the VM(X) folders, this time using only a webpage for each food service provider FSP. First, buyers open an account with Google Wallet, and then buyers download the buyer's App that will be running in the background of the SCP 108 reviewing for new emails 2403 sent by seller's SCP 103.

To purchase food the buyer opens the Google Maps App and looks for the FSP(X)s nearby, selects one and clicks on the associated Web page, then the SCP 108 launches the Internet browser to show the Web page, inside that page selects the products that are wished to order and clicks to buy one or few of the desire items on the menu, as occur in any online store. A new window from the Google Wallet or PayPal or other similar service provider asking the buyer for an authorization 302 to pay for that transaction, after that a confirmation of the payment transaction could appear on the webpage screen and/or an email could be sent seconds later to the buyer. Then the buyer waits until receiving a “Food Ready” message by email 2102, then walks to the FSP, by that time the buyer's App should detect an email 2403 from the seller's App.

The buyer's App running in the background of the SCP 108 reads the message 2403, decrypted to obtain all the required data described before in FIG. 14 plus transaction information. Then the buyer's App generates the command when the buyers push a button to inform the FSP(X) 2501 to deliver the order number that appears on the SCP 2501 screen, confirming that person is the right buyer, the one that purchased that food order.

The SCP 2501 running the Order's App reads the message 109, and then displays the order number to assist the attendant to deliver the right order to the right buyer, also keeps a record of all orders delivered to inform the attendant in the event that the order was already delivered or isn't ready.

The sellers' App running in the SCP 2502 is waiting to receive the email 2404 from Google Wallet, PayPal, etc., informing that a buyer placed/paid for an order. Then, the sellers' App creates an order number, updates the inventory of the items ordered, instructs the cook to prepare the items in that order number, waits until the cook pushes a button indicating that the order is complete, then the App sends an email with the message “Your order # is ready for pickup”, then the App creates and sends the mentioned email message 2403.

FIG. 26 depicts a system for other applications that can be solved by just the message 2403, emailed from the boss, coworker, friend, or family members SCP 2603. The SCP 108 running the buyer's App could be able to receive emails 2403 send by the SCP 2603 and using the low range radio or BLE transmit the message received after the user pushed the “Send” button to a dongle 2601. That capability could create other Apps Like the ones in SCP 2602 and 2603 and also create dongles 2601 to control other devices that require authorization of a remote party. The following are some possible applications: all types of locks, disarming alarms, starting a vehicle, power-on something, power-off something, and to prove that the buyer has the authority to do something, as described in the following example:

A warehouse receives packages from all over the world and wants to deliver the packages to the right addressee and wants to prove the sender precisely that. The two new parties require downloading an App design for that application. The sender using the SCP 2603 and that App push the button “SEND PACK KEY” to sends two encrypted email messages as described before, one the 2605 to the warehouse SCP 2602 App to be stored for later use and the other 2403 to the SCP App 108 of the addressee (buyer) then when the two SCP (2602 and 108) get close, the addressee using the SCP 108 pushes the “SEND” button and the SCP 2602 App of the warehouse receives it and verifies if the messages is acceptable to one of the stored messages to display “GIVE THE PACK” to deliver the package, then sends an encrypted email message 2604 to the sender SCP 2603 App with the pickup confirmation key to be stored in a file for later use.

It will be understood by those skilled in the art of the present invention that it may be embodied in other specific forms without departing from the scope of the invention disclosed and that the examples and embodiments described herein are in all respects illustrative and not restrictive. Those skilled in the art of the present invention will recognize that other embodiments using the concepts described herein are also possible.

This application claims the benefit of U.S. provisional Patent Application Ser. No. 62/285,626, filed Nov. 4, 2015, Ser. No. 62/388,440, filed Jan. 1, 2016, Ser. No. 62/390,444, files Mar. 3, 2016 and Ser. No. 62/390,777 by Fernando Morales, the disclosure of which are incorporated herein by reference.

What is claimed is:

1. A mobile-device-to-machine payment system for facilitating a cashless transaction for purchase of at least one product or service by a user from a payment accepting unit with or without input mechanisms, the user having a mobile device having both short-range communication technology and long-range communication technology, the payment accepting unit capable of dispensing at least one product or service, said system comprising: (a) an adapter module associated with the payment accepting unit, said adapter having short-range communication technology for communicating with the short-range communication technology of the mobile device; (b) that mobile device contains data or gathers it from a cloud stored data using a long-range communication technology to select a product offered by said payment accepting unit; (c) that mobile device paid for the selected product by subtracting from an internal balance or using the long-range communication technology deducts and adds to balances located in the cloud storage or process the payment using a payment service provider; (d) that mobile device using internal data or cloud stored data or emailed data creates and communicates a message to the adapter module associated with the said payment accepting unit using the short-range communication technology; and (e) said adapter module for receiving said message using short-range communication technology, wherein the payment accepting unit dispenses the at least one product or service in response to receiving user input if required to the payment accepting unit if said adapter module has received said message.

2. The system of claim 1 said adapter module having security technology and said mobile device having security technology, said cloud stored data having security technology, said message created by the mobile device having security technology.

3. The system of claim 1 said adapter module and said cloud data hold a unique private key, said adapter module having encryption/decryption technology and said cloud data having encryption/decryption technology, said message being encrypted by said mobile device encryption/decryption technology using said unique private key gather from the cloud data.

4. The system of claim 1 having a hands-free mode in which the payment accepting unit dispenses the at least one product or service without the user interacting with the mobile device and/or without the user interact with the payment accepting unit.

5. The system of claim 1 wherein said adapter module is an in-line circuit for in-line insertion within a multi-drop bus of the payment accepting unit.

6. The system of claim 1: (a) the payment accepting unit having a multi-drop bus to a payment receiving mechanism, the multi-drop bus having a male adapter and a female adapter; (b) said adapter module having a male adapter and a female adapter; and (c) said adapter module pluggable in the multi-drop bus by connecting said male adapter of said adapter module to the female adapter of the multi-drop bus and by connecting said female adapter of said adapter module to the male adapter of the multi-drop bus.

7. A method for using a mobile-device-to-machine payment system for facilitating a cashless transaction for purchase of at least one product or service by a user from a payment accepting unit with or without input mechanism, the user having a mobile device having both short-range communication technology and long-range communication technology, the payment accepting unit capable of dispensing at least one product or service, said method comprising the steps of: (a) using device internal data or gathering cloud stored data using the long-range communication technology of the mobile device to select a product from the paying accepting unit; (b) paying said product selected by deducting from the device internal balance or by using an electronic payment service provider or by modifying cloud stored data using the long-range communication technology of the mobile device; (c) creating a message using device data or cloud storage data or emailed data and communicating said message to the adapter module associated to the payment accepting unit using the mobile device and the short-range communication technology of the mobile device; (d) receiving said message from the short-range communication technology of said mobile device at said adapter module associated with the payment accepting unit, and (e) dispensing the at least one product or service from the payment accepting unit in response to receiving user input if required to the payment accepting unit if said adapter module has received said message.

8. The method of claim 7, securing said message using security technology associated with said adapter module, said mobile device and said cloud stored data.

9. The method of claim 7, keeping a unique private key between said adapter module and said cloud stored data, encrypting using said unique private key said message using encryption/decryption technology associated with said adapter module to create an encrypted message using said mobile device, decrypting using said unique private key said encrypted message using encryption/decryption technology associated with said adapter module.

10. The method of claim 7, having a hands-free mode in which the payment accepting unit dispenses the at least one product or service without the user interacting with the mobile device and/or with the payment accepting unit.

11. The method of claim 7, further comprising the step of inserting said adapter module as an in-line circuit for in-line insertion within a multi-drop bus of the payment accepting unit.

12. The method of claim 7, the payment accepting unit having a multi-drop bus to a payment receiving mechanism, the multi-drop bus having a male adapter and a female adapter, and said adapter module having a male adapter and a female adapter, said method further comprising the step of inserting said adapter module in serial with the multi-drop bus by connecting said male adapter of said adapter module to the female adapter of the multi-drop bus and by connecting said female adapter of said adapter module to the male adapter of the multi-drop bus.
